(19) United States
(12) Patent Application Publication
(10) Pub. No.: US 2025/0035772 A1
(43) Pub. Date: Jan. 30, 2025

(54) REAL-TIME NON-RADIO FREQUENCY OBJECT FEATURE REPORTING FOR RADIO FREQUENCY SENSING

(71) Applicant: QUALCOMM Incorporated, San Diego, CA (US)

(72) Inventors: Weimin DUAN, San Diego, CA (US); Alexandros MANOLAKOS, Athens, Attikí (GR); Fei HUANG, San Diego, CA (US)

(21) Appl. No.: 18/715,406

(22) PCT Filed: Dec. 22, 2022
(86) PCT No.: PCT/US2022/082315

§ 371 Date: May 31, 2024

(30) Foreign Application Priority Data
Feb. 14, 2022 (GR) 20220100137

(51) Int. Cl. G01S 13/86; G01S 7/00

(52) U.S. Cl. CPC G01S 13/86; G01S 7/006

(57) ABSTRACT

Radio frequency (RF) sensing of a target object by a wireless network is supported by a network node that derives one or more object features for the target object using non-RF sensor measurements and reports the object features to a server for the RF sensing. The non-RF sensors, for example, may be one or more of a camera, ultra-sound sensor, lidar, barometer, etc. The object features for the target object, which may be related to the object size, position, motion, etc. may be separately reported for each non-RF technology or may be reported as a common set of object features. The object feature report may include a time stamp, and may associate an object ID for the target object with the reported object features. Some object features may be prioritized over others, and object features that do not change may not be reported in subsequent reports.

### BACKGROUND

### Field

Subject matter disclosed herein relates generally to wireless communication, and more specifically, to radio frequency sensing in a wireless communication system.

### Information:

Radar is a ranging technique that can be used to determine the distances of objects relative to a given location. A radar system operates by transmitting and receiving electromagnetic pulses. Some of the pulses reflect off objects or surfaces along the transmission path, producing “echoes.” The radar system may determine the distances of the objects or surfaces based on a round trip time between the transmission of a pulse to the reception of an echo of that pulse.

In a monostatic radar system, the antennas used to transmit the pulses (“transmit antennas”) are collocated with the antennas used to receive the echoes (“receive antennas”). For example, the transmit antennas and receive antennas are often disposed on the same device. This allows for simple synchronization between the timing of the transmitted pulses and the timing of the received echoes since the same device (or system) clock may be used for both. In a multistatic radar system, the transmit antennas are located a substantial distance away from the receive antennas. The spatial diversity afforded by multistatic radar systems provides a high accuracy of target location and allows different aspects of a target to be viewed simultaneously.

Radio frequency (RF) sensing is a technique, similar to (and may include) radar, that can be used to determine one or more of the presence, location, identity, or combination thereof of objects. RF sensing, for example, may be used in wireless communication systems, such as cellular communications system (5G and 5G beyond). With a large bandwidth allocated to, e.g., 5G and 5G beyond, cellular communications system RF sensing may be considered a critical feature in future cellular systems. Improvements for RF sensing are desired.

### SUMMARY

Radio frequency (RF) sensing of a target object by a wireless network is supported by a network node that derives one or more object features for the target object using non-RF sensor measurements and reports the object features to a server for the RF sensing. The non-RF sensors, for example, may be one or more of a camera, ultra-sound sensor, lidar, barometer, etc. The object features for the target object, which may be related to the object size, position, motion, etc. may be separately reported for each non-RF technology or may be reported as a common set of object features. The object feature report may include a time stamp, and may associate an object ID for the target object with the reported object features. Some object features may be prioritized over others, and object features that do not change may not be reported in subsequent reports.

In one implementation, a method performed by a network node in a wireless network for supporting radio frequency (RF) sensing in the wireless network includes obtaining one or more non-RF measurements associated with a target object of RF sensing; determining one or more object features associated with the target object based on the one or more non-RF measurements; generating an object feature report comprising the one or more object features associated with the target object; and sending the object feature report to a server in the wireless network.

In one implementation, a network node in a wireless network configured for supporting radio frequency (RF) sensing in the wireless network, includes at least one transceiver; one or more non-RF sensors; at least one memory; and at least one processor coupled to the at least one transceiver, the one or more non-RF sensors, and the at least one memory, wherein the at least one processor is configured to cause the network node to: obtain, from the one or more non-RF sensors, one or more non-RF measurements associated with a target object of RF sensing; determine one or more object features associated with the target object based on the one or more non-RF measurements; generate an object feature report comprising the one or more object features associated with the target object; and send, via the at least one transceiver, the object feature report to a server in the wireless network.

In one implementation, a network node in a wireless network configured for supporting radio frequency (RF) sensing in the wireless network, includes means for obtaining one or more non-RF measurements associated with a target object of RF sensing; means for determining one or more object features associated with the target object based on the one or more non-RF measurements; means for generating an object feature report comprising the one or more object features associated with the target object; and means for sending the object feature report to a server in the wireless network.

In one implementation, a non-transitory computer-readable storage medium including program code stored thereon, the program code is operable to configure at least one processor in a network node in a wireless network for supporting radio frequency (RF) sensing in the wireless network, the program code comprising instructions to: obtain one or more non-RF measurements associated with a target object of RF sensing; determine one or more object features associated with the target object based on the one or more non-RF measurements; generate an object feature report comprising the one or more object features associated with the target object; and send the object feature report to a server in the wireless network.

In one implementation, a method performed by a server in a wireless network for supporting radio frequency (RF) sensing in the wireless network includes sending to a network node an indication of object features of a target object of RF sensing to be included in an object feature report; and receiving the object feature report from the network node comprising one or more object features determined by the network node based on one or more non-RF measurements associated with the target object of RF sensing.

In one implementation, a server in a wireless network configured for supporting radio frequency (RF) sensing in the wireless network includes at least one transceiver; at least one memory; and at least one processor coupled to the at least one transceiver, and the at least one memory, wherein the at least one processor is configured to cause the network node to: send, via the at least one transceiver, to a network node an indication of object features of a target object of RF sensing to be included in an object feature report; and receive, via the at least one transceiver, the object feature report from the network node comprising one or more object features determined by the network node based on one or more non-RF measurements associated with the target object of RF sensing.

In one implementation, a server in a wireless network configured for supporting radio frequency (RF) sensing in the wireless network includes means for sending to a network node an indication of object features of a target object of RF sensing to be included in an object feature report; and means for receiving the object feature report from the network node comprising one or more object features determined by the network node based on one or more non-RF measurements associated with the target object of RF sensing.

In one implementation, a non-transitory computer-readable storage medium including program code stored thereon, the program code is operable to configure at least one processor in a server in a wireless network for supporting radio frequency (RF) sensing in the wireless network, the program code comprising instructions to: send to a network node an indication of object features of a target object of RF sensing to be included in an object feature report; and receive the object feature report from the network node comprising one or more object features determined by the network node based on one or more non-RF measurements associated with the target object of RF sensing.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to various aspects of the disclosure.

FIG. 2 illustrates a block diagram of a design of base station and user equipment (UE), which may be one of the base stations and one of the UEs in FIG. 1.

FIG. 3 illustrates a UE configured for generating an object feature report based on non-RF measurements for supporting RF sensing in a wireless network.

FIG. 4 illustrates a base station configured for generating an object feature report based on non-RF measurements for supporting RF sensing in a wireless network.

FIG. 5 illustrates a server configured for receiving an object feature report based on non-RF measurements for supporting RF sensing in a wireless network.

FIG. δ shows an example of a bistatic radar system that may be used for RF sensing.

FIG. 7 illustrates an example of deriving object features from an image captured with a camera.

FIG. 8 is a message flow illustrating the messaging between a network node and a server for the generation and transmission of object feature reports based on non-RF measurements for supporting RF sensing of a target object.

FIG. 9 shows a flowchart for an exemplary process for supporting radio frequency (RF) sensing in a wireless network using object feature reports derived based on non-RF measurements.

FIG. 10 shows a flowchart for an exemplary process for supporting radio frequency (RF) sensing in a wireless network using object feature reports derived based on non-RF measurements.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). A communication link through which a UE signals to another UE is called a sidelink (SL) or sidelink channel. As used herein, the term traffic channel (TCH) can refer to either an UL/reverse, DL/forward, or SL traffic channel.

The term “base station” may refer to a single physical transmission-reception point (TRP), which may also be referred to as a transmit/receive point, or to multiple physical TRPs that may or may not be co-located. For example, where the term “base station” refers to a single physical TRP, the physical TRP may be an antenna of the base station corresponding to a cell of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring.

A RF sensing system may employ a RF sensing server to support determining characteristics of one or more objects, such as the relative location, identity, motion state, etc., in a wireless network (e.g., a cellular network). The RF sensing server may be part of or accessible from a serving network or a home network for a UE or may simply be accessible over the Internet or over a local Intranet. With increasingly large bandwidths (BW) allocated for cellular communications system (5G and 5G beyond) and more use cases being introduced with cellular communications system, RF sensing may be considered a critical feature in future cellular systems.

In a traditional RF sensing designs, the waveform design and resource allocation for RF sensing only consider the upper bound of the performance metrics, such as the maximum range, and the range and/or Doppler resolution. Thus, the framework for traditional RF sensing is not flexible enough to adapt to a dynamic environment, e.g., particularly for a wide area outdoor sensing use case.

With the use of RF sensing that is adaptive to the environment, various improvements in the sensing performance, spectrum efficiency of the cellular systems and power efficiency of the sensing node (e.g., the base station or UE) may be obtained. For example, if the network, e.g., the RF sensing server, knows the direction of the target, it could guide the radar transmission (Tx) to beamform toward the target to enhance the signal to noise ratio (SNR). In another example, if the network knows there is no small objects to be sensed, it could reduce Tx power and/or waveform repetitions to achieve power saving.

In order for the network, e.g., the RF sensing server, to obtain information about the environment and targets to be sensed, object features may be reported to the network by one or more network nodes, e.g., by one or more UEs and/or one or more base stations. A network node such as a UE may report object features, e.g., using RAT-dependent lower layer channels, such as the physical layer (PHY) or the medium access control—control element (MAC-CE) channels, including by way of example, a physical uplink shared channel (PUSCH) or a physical uplink control channel (PUCCH). A network node such as a base station may report object features using other signaling, such as NR Positioning Protocol A (NRPPa). The object features, for example, may be any parameters related to the object, including information about the object itself as well as nearby environmental factors, that may be used by the network to enable adaptive RF sensing. The object features reported by one or more network nodes may be derived through non-RF methods, for example, using measurements obtained via a camera, ultra-sound sensor, light detection and ranging (lidar), barometer, etc. The object features may be extracted from non-RF measurements, e.g., on the device in a real-time fashion. The use of non-RF measurements to obtain object features is advantageous as it eliminates interference issues that would arise if RF based feature extraction were used, as well as reduces power requirements.

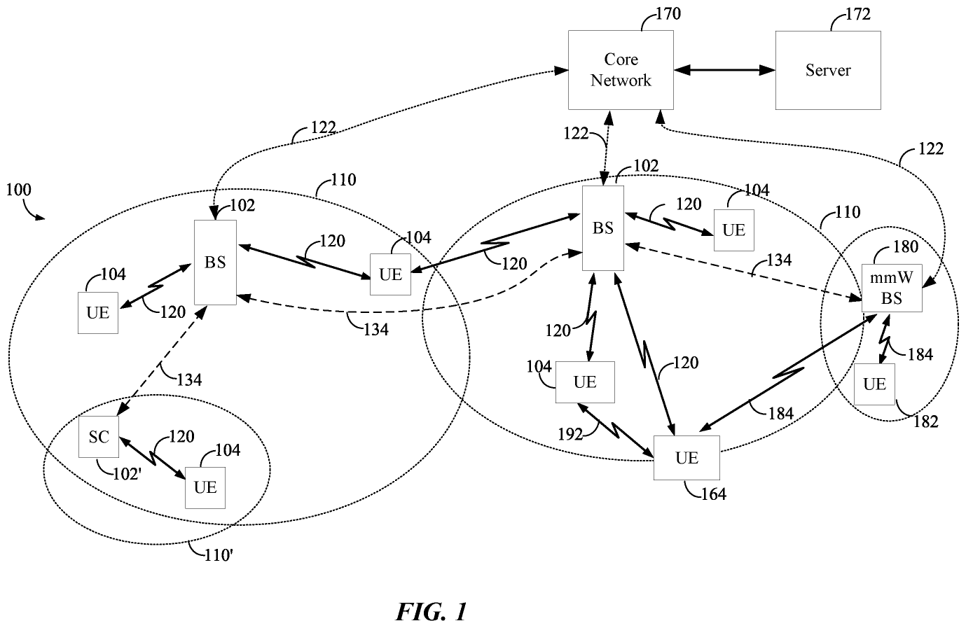

FIG. 1 illustrates an example wireless communications system 100. The wireless communications system 100 (which may also be referred to as a wireless wide area network (WWAN) or a wireless network (e.g., a cellular network) may include various base stations 102, sometimes referred to herein as gNBs 102 or other types of NBs, and various UEs 104. The base stations 102 may include macro cell base stations (high power wireless base stations) and/or small cell base stations (low power wireless base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to one or more RF sensing servers 172. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by a WLAN AP. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs that connects indirectly to one or more communication networks via one or more device-to-device (D2D) peer-to-peer (P2P) links. In the example of FIG. 1, UE 164 has a D2D P2P link 192 with one of the UEs 104 connected to one of the base stations 102. Link 192 may be used to indirectly obtain wireless connectivity or for D2D communications between UEs 104 and 164 without use of the base station 102. In some implementations, the link 192 is a sidelink (SL) between the UEs 104 and 164. In an example, the D2D P2P link 192 may be supported with any well-known D2D RAT, such as LTE Direct (LTE-D), WiFi Direct (WiFi-D), Bluetooth®, and so on.

The wireless communications system 100 may include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

The RF sensing server 172 may include one or more RF sensing servers that are to configure the wireless network to support RF sensing that is adaptive to the environment based on object feature reports received from one or more network nodes, which may be UEs 104 or base stations 102. RF sensing server 172, for example, may configure the waveform design and resource allocation for RF sensing based on the object feature reports, as opposed to using only an upper bound of performance metrics, such as a maximum range or the range and/or Doppler resolution. For example, the RF sensing server 172 may determine the direction of an object based on the object feature report and may guide transmissions to beamform toward the object to improve SNR. In another example, the RF sensing server 172 may obtain the size of the object based on the object feature report and may tailor transmissions based on the size of the object, e.g., by reducing power and/or waveform repetitions if the object is large, e.g., for power savings, or to increase power and/or waveform repetitions is the object is small, e.g., for improved resolution. The RF sensing server 172 may further determine environmental conditions near the object based on the based on the object feature report which may be used to tailor transmissions.

The one or more network nodes (e.g., UEs 104 and/or base stations 102) may derive one or more object features associated with one or more objects, and provide an object feature report to the network, e.g., the RF sensing server 172. For the sake of simplicity, the network nodes will sometimes be referred to herein simply as a UE 104, but it should be understood that base stations 102 may also serve as a network node that derives and reports one or more object features. The object feature report provided by a network node may include object features related to one or more objects, including information about the object itself, e.g., relative location of the object with respect to the network node, size of the object, object class, motion state, etc., as well as nearby environmental factors near the object, such as atmospheric pressure. The object feature report, for example, may be reported to the network, e.g., RF sensing server 172, by a UE 104 via RAT-dependent lower layer channels, such as PHY or MAC-CE, including PUSCH or PUCCH. The object feature report, for example, may be reported to the network, e.g., RF sensing server 172, by a base station 102 using other signaling, such as NRPPa.

The object features that are included in the object feature report(s) provided by the one or more network nodes may be determined using non-RF technologies, such as a camera, ultra-sound sensor, lidar, barometer, etc. The use of non-RF technologies to derive the object features advantageously eliminates interference with RF sensing, which would occur if the network node were to use RF technologies to obtain the object features, and additionally reduces power requirements. The object features may be extracted from non-RF measurements by the network node in a real-time fashion and provided to the RF sensing server 172. The object features in an object feature report may have a same format as used in RF sensing measurement reports.

In some implementations, the object features may be reported differently for each non-RF technology. The object features that are reported for each non-RF technology may be defined in a standard, to assist the network, e.g., the RF sensing server 172, to decode the object features. For example, object features derived from a camera may be reported as the object class (e.g., human, car, bicycle, dog, cat, etc.), the estimated size, the motion status of the object, and orientation (e.g., direction) with respect to the network node. Object features derived from a lidar and/or ultra-sound may be reported as a range (e.g., distance from the network node), orientation (e.g., direction) with respect to the network node, estimated size, and object class. Object features derived from a barometric sensor may include the atmospheric pressure.

In another implementation, a common set of features for the different non-RF technologies, may be reported to the network, e.g., the RF sensing server 172. The common set of features, for example, may include the radar cross section (RCS), e.g., including the RCS variance, speed, position, trajectory, direction (e.g., angle with respect to the network node), or any combination thereof. The network node may derive the common set of features based on measurements from non-RF sensors.

Additionally, the object feature report provided to the network, e.g., the RF sensing server 172, by the network node may include a time stamp. A single time stamp associated with all of the object features may be provided. In another implementation, a time stamp associated with each derived feature based on the time of measurement from the non-RF sensors may be provided.

The object feature report may include object features for a plurality of objects. Thus, object features associated with different objects may be derived by the network node and reported. A different object identity (ID) may be defined for each object, e.g., by the network node or the network, e.g., the RF sensing server 172. The object features in the object feature report may be associated with the object ID of the object to which the object features belong.

The network node may provide object feature reports periodically. Moreover, the object feature report may include the report period. Because the UL channel resource is limited, the network node may follow priority rules for providing object feature reports. For example, if multiple object feature reports are configured in the same channel, the network node may follow priority rules, e.g., based on use case, which may be dynamically indicated by the network, e.g., RF sensing server 172, or the network node. Additionally, the network node may skip reporting object features if the object feature is highly correlated with the object feature provided in a previous report, which avoids reporting redundant features within a time window. The network, e.g., RF sensing server 172, may presume that there is no update to an object feature if the network node skips reporting the object feature.

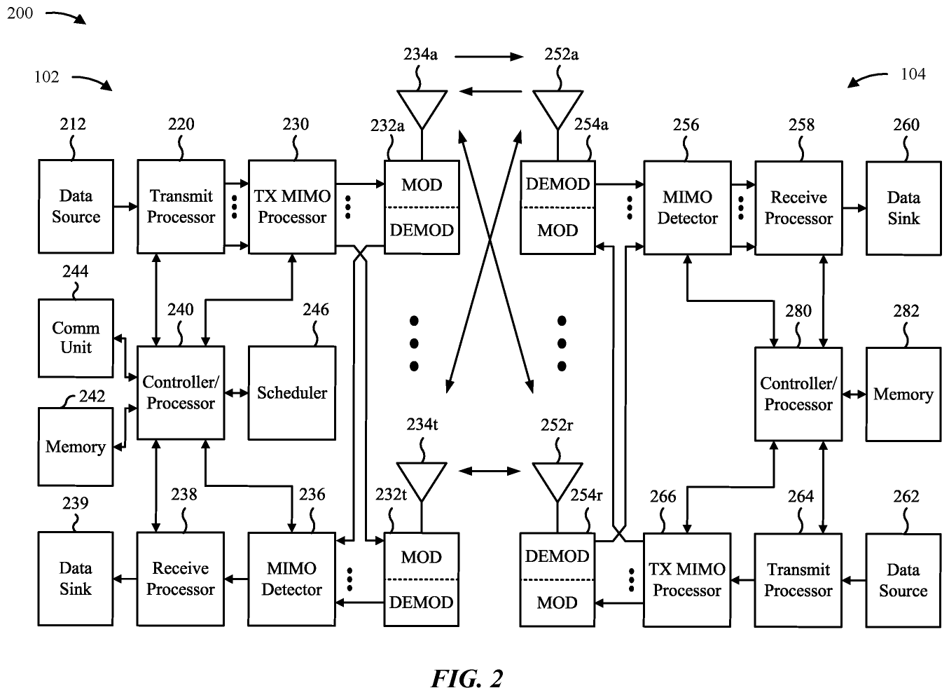

FIG. 2 shows a block diagram of a design 200 of a base station 102 and a UE 104, which may be one of the base stations and one of the UEs in FIG. 1. While design 200 depicts communications between a base station 102 and a UE 104 for the depicted examples below in describing aspects of the present disclosure, communications may be between two UEs 104 over a SL (such as a UE communicating with a relay UE), two base stations 102, or other devices of the wireless communication system 100. Referring to the design 200, base station 102 may be equipped with T antennas 234a through 234t, and UE 104 may be equipped with R antennas 252a through 252r, where in general T>1 and R>1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. Each demodulator 254 may condition (e.g., filter, amplify, down convert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 104 may be included in a housing.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r, and transmitted to base station 102. At base station 102, the uplink signals from UE 104 and other UEs may be received by antennas 234, processed by demodulators 232, detected by a MIMO detector 236 if applicable, and further processed by a receive processor 238 to obtain decoded data and control information sent by UE 104. Receive processor 238 may provide the decoded data to a data sink 239 and the decoded control information to controller/processor 240. Base station 102 may include communication unit 244 and communicate to another device (such as core network component) via communication unit 244.

Controller/processor 240 of base station 102, controller/processor 280 of UE 104, and/or any other component(s) of FIG. 2 may perform one or more techniques associated with RF sensing services, as described in more detail elsewhere herein. For example, controller/processor 240 of base station 102, controller/processor 280 of UE 104, and/or any other component(s) of FIG. 2 may perform or direct operations of, for example, the described processes depicted in the figures and/or other processes as described herein. Memories 242 and 282 may store data and program codes for base station 102 and UE 104, respectively. In some aspects, memory 242 and/or memory 282 may comprise a non-transitory computer-readable medium storing one or more instructions for wireless communication. For example, the one or more instructions, when executed by one or more processors of base station 102 and/or the UE 104 may perform or direct operations of the processes as described herein. A scheduler 246 may schedule UEs for data transmission on the downlink and/or uplink. In some implementations, a scheduler may be used by a UE 104 for data transmission on a sidelink.

As indicated above, FIG. 2 is provided as an example. Other examples may differ from what is described with regard to FIG. 2 (such as communications between two UEs or other types of devices of the wireless network).

In the frequency domain for an uplink, downlink, or sidelink transmission, the available bandwidth may be divided into uniformly spaced orthogonal subcarriers (also referred to as “tones” or “bins”). For example, for a normal length cyclic prefix (CP) using, for example, 15 kHz spacing, subcarriers may be grouped into a group of 12 subcarriers. A resource of one OFDM symbol length in the time domain and one subcarrier in the frequency domain is referred to as a resource element (RE). Each grouping of the 12 subcarriers and 14 OFDM symbols is termed a resource block (RB) and, in the example above, the number of subcarriers in a resource block may be written as N_{SC}^{RB}=12. For a given channel bandwidth, the number of available resource blocks on each channel, which is also called a transmission bandwidth configuration, is indicated as N_{RB}^{DL}. For example, for a 3 MHz channel bandwidth in the above example, the number of available resource blocks on each channel is given by N_{RB}^{DL}=15. Note that the frequency component of a resource block (e.g., the 12 subcarriers) is referred to as a physical resource block (PRB).

A collection of resource elements that are used for RF sensing may be referred to as a “radar reference signal (RRS).” If the resource elements are from one or more RRS signals, the collection of resource elements may be referred to as a “RRS resource.” The collection of resource elements can span multiple PRBs in the frequency domain and one or more symbol(s) within a slot or across slots in the time domain. A base station or UE may transmit resources (such as the RRS resources) for use in RF sensing services. For example, an indication of one or more RRS resources to be used may be received at a communication unit 244 of base station 102 from a RF sensing server 172. In some implementations, the base station 102 may configure itself to transmit the one or more RRS resources over a downlink. In some implementations, the base station 102 may indicate the one or more RRS resources to one or more UEs 104, and a UE 104 may transmit the one or more RRS resources over a sidelink.

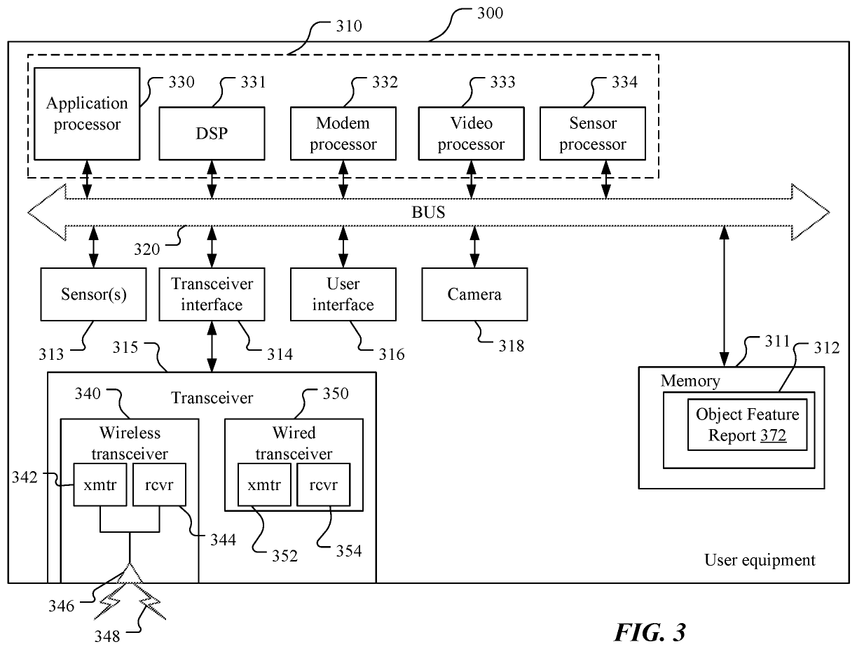

FIG. 3 illustrates a UE 300, which is an example of the UE 104, configured for generating an object feature report based on non-RF measurements for supporting RF sensing in a wireless network (such as wireless communication system 100). The UE 300 may be further configured to transmit and/or receive one or more RRS resources based on the RRS resources configured by the RF sensing server 172 based at least in part on the object feature report. The UE 300 includes a computing platform including at least one processor 310, memory 311 including software (SW) 312, one or more sensors 313, a transceiver interface 314 for a transceiver 315, a user interface 316, and a camera 318. The processor 310, the memory 311, the sensor(s) 313, the transceiver interface 314, the user interface 316, and the camera 318 may be communicatively coupled to each other by a bus 320 (which may be configured, e.g., for optical and/or electrical communication). One or more of the shown apparatus (e.g., the camera 318 and/or one or more of the sensor(s) 313, etc.) may be omitted from the UE 300 or the UE 300 may include additional apparatus not shown (e.g., a positioning system receiver (such as a global navigation satellite system (GNSS) or a global positioning system (GPS) receiver and processing components)). The processor 310 may include one or more intelligent hardware devices, e.g., a central processing unit (CPU), a microcontroller, an application specific integrated circuit (ASIC), etc. The processor 310 may comprise multiple processors including an application processor 330, a Digital Signal Processor (DSP) 331, a modem processor 332, a video processor 333, and/or a sensor processor 334. One or more of the processors 330-334 may comprise multiple devices (e.g., multiple processors). For example, the sensor processor 334 may comprise, e.g., processors for radar, ultrasound, and/or lidar, etc. The modem processor 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 300 for connectivity. The memory 311 is a non-transitory storage medium that may include random access memory (RAM), flash memory, disc memory, and/or read-only memory (ROM), etc. The memory 311 stores the software 312, which may be processor-readable, processor-executable software code containing instructions that are configured to, when executed, cause the processor 310 to operate as a special purpose computer programmed to perform the various functions described herein. Alternatively, the software 312 may not be directly executable by the processor 310 but may be configured to cause the processor 310, e.g., when compiled and executed, to operate as a special purpose computer to perform the various functions described herein. The description may refer only to the processor 310 performing a function, but this includes other implementations such as where the processor 310 executes software and/or firmware. The description may refer to the processor 310 performing a function as shorthand for one or more of the processors 330-334 performing the function. The description may refer to the UE 300 performing a function as shorthand for one or more appropriate components of the UE 300 performing the function. The processor 310 may include a memory with stored instructions in addition to and/or instead of the memory 311. Functionality of the processor 310 is discussed more fully below.

The configuration of the UE 300 shown in FIG. 3 is an example and not limiting of the disclosure, including the claims, and other configurations may be used. For example, an example configuration of the UE includes one or more of the processors 330-334 of the processor 310, the memory 311, and the wireless transceiver 340. Other example configurations include one or more of the processors 330-334 of the processor 310, the memory 311, the wireless transceiver 340, and one or more of the sensor(s) 313, the user interface 316, the camera 318, and/or the wired transceiver 350.

The UE 300 may comprise the modem processor 332 that may be capable of performing baseband processing of signals received and down-converted by the transceiver 315. The modem processor 332 may perform baseband processing of signals to be upconverted for transmission by the transceiver 315. Also or alternatively, baseband processing may be performed by the processor 330 and/or the DSP 331. Other configurations, however, may be used to perform baseband processing.

The UE 300 may include the sensor(s) 313 that may include, for example, one or more of various types of sensors such as one or more inertial sensors, one or more barometric pressure sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 300 in three dimensions) and/or one or more gyroscopes capable of detecting motion including rotation of the UE 300. The sensor(s) 313 may include one or more magnetometers to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 313 may generate analog and/or digital signals indications of which may be stored in the memory 311 and processed by the DSP 331 and/or the processor 330 in support of one or more applications such as, for example, applications directed to positioning and/or navigation operations.

The sensor(s) 313 may be used in relative location measurements, relative location determination, motion determination, etc. Information detected by the sensor(s) 313 may be used for object feature determination, motion detection, relative displacement, dead reckoning, sensor-based location determination, and/or sensor-assisted location determination. The IMU may be configured to provide measurements about a direction of motion and/or a speed of motion of the UE 300, which may be used in relative location determination. For example, one or more accelerometers and/or one or more gyroscopes of the IMU may detect, respectively, a linear acceleration and a speed of rotation of the UE 300. The linear acceleration and speed of rotation measurements of the UE 300 may be integrated over time to determine an instantaneous direction of motion as well as a displacement of the UE 300. The instantaneous direction of motion and the displacement may be integrated to track a location of the UE 300. For example, a reference location of the UE 300 may be determined for a moment in time, and measurements from the accelerometer(s) and gyroscope(s) taken after this moment in time may be used in dead reckoning to determine present location of the UE 300 based on movement (direction and distance) of the UE 300 relative to the reference location.

The magnetometer(s) may determine magnetic field strengths in different directions which may be used to determine orientation of the UE 300. For example, the orientation may be used to provide a digital compass for the UE 300. The magnetometer may be a two-dimensional magnetometer configured to detect and provide indications of magnetic field strength in two orthogonal dimensions. Alternatively, the magnetometer may be a three-dimensional magnetometer configured to detect and provide indications of magnetic field strength in three orthogonal dimensions. The magnetometer may provide means for sensing a magnetic field and providing indications of the magnetic field, e.g., to the processor 310.

The barometric pressure sensors(s) may determine air pressure, which may be used to determine the atmospheric pressure near an object or the elevation or current floor level in a building of the UE 300. For example, a differential pressure reading may be used to detect when the UE 300 has changed floor levels as well as the number of floors that have changed. The barometric pressure sensors(s) may provide means for sensing air pressure and providing indications of the air pressure, e.g., to the processor 310.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels and/or one or more sidelink channels) and/or receiving (e.g., on one or more downlink channels and/or one or more sidelink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with a base station and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 350 may include a transmitter 352 and a receiver 354 configured for wired communication. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication. The transceiver 315 may be communicatively coupled to the transceiver interface 314, e.g., by optical and/or electrical connection. The transceiver interface 314 may be at least partially integrated with the transceiver 315. In some implementations, the transceiver 315 does not include a wired transceiver 350.

The antennas 346 may include an antenna array, which may be capable of receive beamforming or transmit beamforming, e.g., by increasing the gain setting and/or adjust the phase setting of an array of antennas in a particular direction to amplify (e.g., to increase the gain level of) the RF signals received from or transmitted towards that direction. The antennas 346 may further include a plurality of antenna panels, wherein each antenna panel is capable of beamforming. The antennas 346 are capable of adaptation, e.g., selection of one or more antennas for controlling receiving transmitted beams from or transmitting beams towards a base station or another UE. A reduced number of beams or a single beam, for example, may be selected for reception of a wide angle beam, e.g., to reduce power consumption, while an increased number of antennas in an antenna array may be selected when the transmit beam is relatively narrow. Conversely, the antennas 346 may be configured to transmit a wide angle beam or a relatively narrow beam.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the UE 300. For example, the user interface 316 may store indications of analog and/or digital signals in the memory 311 to be processed by DSP 331 and/or the processor 330 in response to action from a user. Similarly, applications hosted on the UE 300 may store indications of analog and/or digital signals in the memory 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 316 may comprise one or more touch sensors responsive to touching and/or pressure, e.g., on a keyboard and/or touch screen of the user interface 316.

The UE 300 may include the camera 318 for capturing still or moving imagery, e.g., of an object for RF sensing. The camera 318 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 330 and/or the DSP 331. For example, the captured images may be processed to generate a segmentation map, which may be used to generate a category map, to classify one or more objects in the image, e.g., as human, car, bicycle, etc. Also or alternatively, the video processor 333 may perform conditioning, encoding, compression, and/or manipulation of signals representing captured images. The video processor 333 may decode/decompress stored image data for presentation on a display device (not shown), e.g., of the user interface 316.

The memory 311 may store software 312 that contains executable program code or software instructions that when executed by the processor 310 may cause the processor 310 to operate as a special purpose computer programmed to perform the functions disclosed herein. As illustrated, the memory 311 may include one or more components or modules that may be implemented by the processor 310 to perform the disclosed functions. While the components or modules are illustrated as software 312 in memory 311 that is executable by the processor 310, it should be understood that the components or modules may be stored in another computer readable medium or may be dedicated hardware either in the processor 310 or off the processor. A number of software modules and data tables may reside in the memory 311 and be utilized by the processor 310 in order to manage both communications and the functionality described herein. It should be appreciated that the organization of the contents of the memory 311 as shown is merely exemplary, and as such the functionality of the modules and/or data structures may be combined, separated, and/or be structured in different ways depending upon the implementation.

The memory 311, for example, may include an object feature report module 372 that when implemented by the one or more processors 310 configures the one or more processors 310 to engage in derivation of object features from non-RF sensor measurements of one or more objects, and to provide the object features in an object feature report to the network, e.g., via transceiver 315. The object feature report, for example, may be transmitted via RAT-dependent lower layer channels, such as PHY or MAC-CE channels, e.g., via PUSCH or PUCCH. The object features may be derived from measurements generated by non-RF sensors, which may include one or more sensor(s) 313, such as ultra-sound sensor, lidar, barometer, etc., and/or the camera 318, or a combination thereof. For example, object features derived from camera 318 may include the object class (e.g., human, car, bicycle, dog, cat, etc.), the estimated size, the motion status of the object, and orientation (e.g., direction) with respect to the UE. The estimated size may be determined based on the object class, as well as the cross section of the object in the image. The motion status of the object, for example, may be determined based on displacement of the object in multiple images, and the time between images. The orientation of the object may be determined based on the orientation of the UE 300, determined from a magnetometer, at the time that the image is captured.

Object features derived from a lidar and/or ultra-sound may be reported as a range (e.g., distance from the UE), orientation (e.g., direction) with respect to the UE 104, estimated size, and object class. For example, the range to the UE may be determined based on the time of flight of the lidar and/or ultra-sound signal. The orientation of the object may be determined based on the orientation of the UE 300, determined from a magnetometer, at the time that the image is captured. Based on the range and orientation of the object with respect to the UE 300, as well as a known position of the UE 300, e.g., determined from a GNSS sensor or cellular positioning techniques, the estimated location of the object may be determined. The estimated size, as well as classification, of an object may be determined based on from lidar and/or ultra-sound, e.g., using topography mapping.

Object features derived from a barometric sensor may include the atmospheric pressure.

In some implementations, the one or more processors 310 may be configured by the object feature report module 372 in memory 311 to derive a common set of features for the different non-RF technologies, that are reported. The common set of features, for example, may include the radar cross section (RCS), e.g., including the RCS variance, e.g., based on the estimated size of the object determined from one or more different non-RF sensor measurements, such as the camera, lidar, ultra-sound, or a combination thereof. Object features, such as the speed, position, trajectory, and direction (with respect to the UE) of the object may be determined from one or more different non-RF sensor measurements, such as the camera, lidar, ultra-sound, magnetometer, GNSS sensor, or a combination thereof.

The one or more processors 310 may be configured to provide its capabilities for generating object features using non-RF measurements, e.g., to the network or RF sensing serving 172, via the transceiver 315. The one or more processors 310 may be configured to receive from the network or RF sensing serving 172 the configuration of object features to be reported, via the transceiver 315.

The one or more processors 310 may additionally be configured to include time stamp associated with one or more object features in the object feature report. The time stamp may be a single time stamp associated with the object features or separate time stamps for different object features obtained using different non-RF sensors. Additionally, the object feature report may include an object ID that identifies the object from which the object features are derived. The object feature report may further include the report period for which the object features are applicable, and may skip reporting an object feature if it is highly correlated with the object feature provided in a previous report, e.g., changes in the object feature are below a predetermined threshold. The one or more processors 310 may be further configured to send, via the transceiver 315, a request to the RF sensing server 172, or may receive a request from the RF sensing server 172, to prioritize object features, and may prioritize the object features accordingly. The object features in the object feature report may have a same format as used in RF sensing measurement reports.

While the object feature report module 372 is depicted as being software included in memory 311, the object feature report module 372 may be a hardware module, a software module, or a combination of hardware and software. For example, the module may include one or more application specific integrated circuits (ASICs), executable code, or a combination of both.

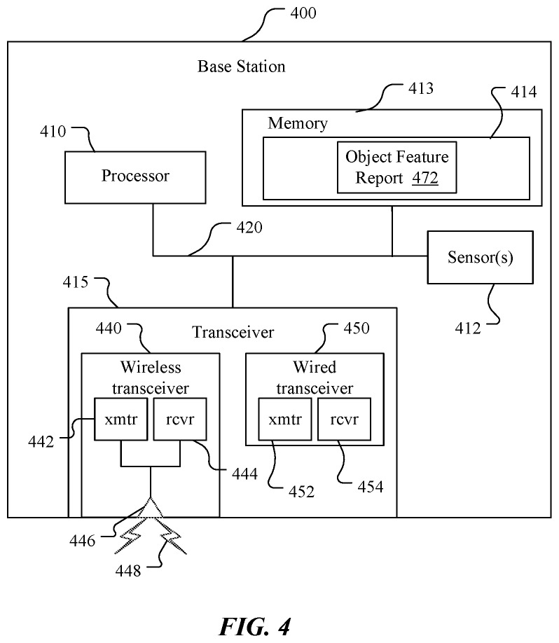

FIG. 4 illustrates a base station 400, which is an example of the base station 102, configured for generating an object feature report based on non-RF measurements for supporting RF sensing in a wireless network (such as wireless communication system 100). The base station 400 may be further configured to transmit and/or receive one or more RRS resources based on the RRS resources configured by the RF sensing server 172 based at least in part on the object feature report. The base station 400 includes a computing platform including a at least one processor 410, memory 413 including software (SW) 414, one or more sensors 412, and a transceiver 415. The processor 410, the memory 413, and the transceiver 415 may be communicatively coupled to each other by a bus 420 (which may be configured, e.g., for optical and/or electrical communication). One or more of the shown apparatus may be omitted from the base station 400, or the base station 400 may include one or more apparatus not shown. The processor 410 may include one or more intelligent hardware devices, e.g., a central processing unit (CPU), a microcontroller, an application specific integrated circuit (ASIC), etc. The one or more sensors 412 may include, e.g., radar, ultrasound, lidar, and a camera, similar to the one or more sensors 313 (and the camera 318) described in FIG. 3. The processor 410 may comprise multiple processors (e.g., including one or more of an application processor, a DSP, a modem processor, a video processor, and/or a sensor processor for radar, ultrasound, lidar, and/or the camera, etc., similar to that shown in FIG. 3). The memory 413 is a non-transitory storage medium that may include random access memory (RAM)), flash memory, disc memory, and/or read-only memory (ROM), etc. The memory 413 stores the software 414 which may be processor-readable, processor-executable software code containing instructions that are configured to, when executed, cause the processor 410 to operate as a special purpose computer programmed to perform the various functions described herein. Alternatively, the software 414 may not be directly executable by the processor 410 but may be configured to cause the processor 410, e.g., when compiled and executed, to operate as a special purpose computer to perform the various functions described herein. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the base station 400 performing a function as shorthand for one or more appropriate components of the base station 400 performing the function. The processor 410 may include a memory with stored instructions in addition to and/or instead of the memory 413. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting and/or receiving (e.g., on one or more uplink channels and/or one or more downlink channels) wireless signals 448 and transducing signals from the wireless signals 448 to wired (e.g., electrical and/or optical) signals and from wired (e.g., electrical and/or optical) signals to the wireless signals 448. The antenna 446 is one or more antenna arrays capable of beam forming and transmitting and receiving beams, including beams used in transmitting or receiving signals (including RRS resources) to support RF sensing of an object. The transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 300, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., to send communications to, and receive communications from, the RF sensing server 172. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the base station 400 shown in FIG. 4 is an example and not limiting of the disclosure, including the claims, and other configurations may be used. For example, the description herein discusses that the base station 400 is configured to perform or performs several functions, but one or more of these functions may be performed by the RF sensing server 172 and/or the UE 300.

The memory 413 may store software 414 that contains executable program code or software instructions that when executed by the processor 410 may cause the processor 410 to operate as a special purpose computer programmed to perform the functions disclosed herein. As illustrated, the memory 413 may include one or more components or modules that may be implemented by the processor 410 to perform the disclosed functions. While the components or modules are illustrated as software 414 in memory 413 that is executable by the processor 410, it should be understood that the components or modules may be stored in another computer readable medium or may be dedicated hardware either in the processor 410 or off the processor. A number of software modules and data tables may reside in the memory 413 and be utilized by the processor 410 in order to manage both communications and the functionality described herein. It should be appreciated that the organization of the contents of the memory 413 as shown is merely exemplary, and as such the functionality of the modules and/or data structures may be combined, separated, and/or be structured in different ways depending upon the implementation.

The memory 413, for example, may include an object feature report module 472 that when implemented by the one or more processors 410 configures the one or more processors 410 to engage in derivation of object features from non-RF sensor measurements of one or more objects, and to provide the object features in an object feature report to the network, e.g., via transceiver 415. The object feature report, for example, may be transmitted via RAT-dependent lower layer channels, such as PHY or MAC-CE channels, e.g., via PUSCH or PUCCH. The object features may be derived from measurements generated by non-RF sensors, which may include one or more sensor(s) 412, such as ultra-sound sensor, lidar, barometer, etc., and/or the camera, or a combination thereof. For example, object features derived from camera may include the object class (e.g., human, car, bicycle, dog, cat, etc.), the estimated size, the motion status of the object, and orientation (e.g., direction) with respect to the base station. The estimated size may be determined based on the object class, as well as the cross section of the object in the image. The motion status of the object, for example, may be determined based on displacement of the object in multiple images, and the time between images. The orientation of the object may be determined based on the known and fixed orientation of the base station 400.

Object features derived from a lidar and/or ultra-sound may be reported as a range (e.g., distance from the base station 400), orientation (e.g., direction) with respect to the base station 400, estimated size, and object class. For example, the range to the base station 400 may be determined based on the time of flight of the lidar and/or ultra-sound signal. The orientation of the object may be determined based on the known and fixed orientation of the base station 400. Based on the range and orientation of the object with respect to the base station 400, as well as a known position of the base station 400, the estimated location of the object may be determined. The estimated size, as well as classification, of an object may be determined based on from lidar and/or ultra-sound, e.g., using topography mapping.

Object features derived from a barometric sensor may include the atmospheric pressure.

In some implementations, the one or more processors 410 may be configured by the object feature report module 472 in memory 413 to derive a common set of features for the different non-RF technologies, that are reported. The common set of features, for example, may include the radar cross section (RCS), e.g., including the RCS variance, e.g., based on the estimated size of the object determined from one or more different non-RF sensor measurements, such as the camera, lidar, ultra-sound, or a combination thereof. Object features, such as the speed, position, trajectory, and direction (with respect to the base station 400) of the object may be determined from one or more different non-RF sensor measurements, such as the camera, lidar, ultra-sound, magnetometer, GNSS sensor, or a combination thereof.

The one or more processors 410 may be configured to provide its capabilities for generating object features using non-RF measurements, e.g., to the network or RF sensing serving 172, via the transceiver 415. The one or more processors 410 may be configured to receive from the network or RF sensing serving 172 the configuration of object features to be reported, via the transceiver 415.

The one or more processors 410 may additionally be configured to include time stamp associated with one or more object features in the object feature report. The time stamp may be a single time stamp associated with the object features or separate time stamps for different object features obtained using different non-RF sensors. Additionally, the object feature report may include an object ID that identifies the object from which the object features are derived. The object feature report may further include the report period for which the object features are applicable, and may skip reporting an object feature if it is highly correlated with the object feature provided in a previous report, e.g., changes in the object feature are below a predetermined threshold. The one or more processors 410 may be further configured to send, via the transceiver 415, a request to the RF sensing server 172, or may receive a request from the RF sensing server 172, to prioritize object features, and may prioritize the object features accordingly. The object features in the object feature report may have a same format as used in RF sensing measurement reports.

While the object feature report module 472 is depicted as being software included in memory 413, the object feature report module 472 may be a hardware module, a software module, or a combination of hardware and software. For example, the module may include one or more application specific integrated circuits (ASICs), executable code, or a combination of both.

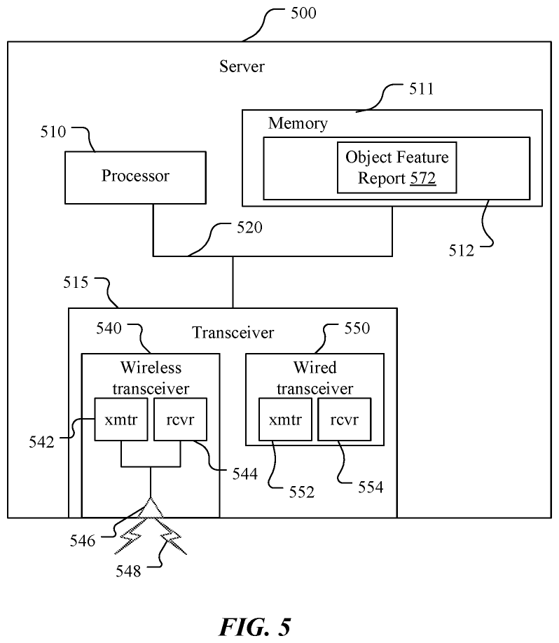

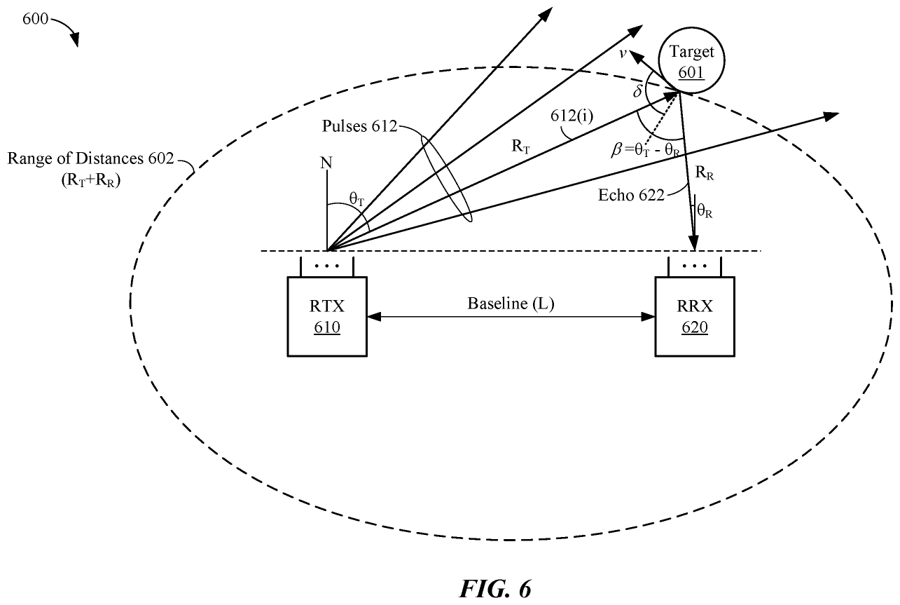

FIG. 5 illustrates a server 500, which is an example of the RF sensing server 172, configured for receiving an object feature report based on non-RF measurements from a network node, such as the UE or base station that may be used for supporting RF sensing in a wireless network (such as wireless communication system 100). The server 500 includes a computing platform including a at least one processor 510, memory 511 including software (SW) 512, and a transceiver 515. The processor 510, the memory 511, and the transceiver 515 may be communicatively coupled to each other by a bus 520 (which may be configured, e.g., for optical and/or electrical communication). One or more of the shown apparatus may be omitted from the server 500, or the server 500 may include one or more apparatus not shown. The processor 510 may include one or more intelligent hardware devices, e.g., a central processing unit (CPU), a microcontroller, an application specific integrated circuit (ASIC), etc. The processor 510 may comprise multiple processors. The memory 511 is a non-transitory storage medium that may include random access memory (RAM)), flash memory, disc memory, and/or read-only memory (ROM), etc. The memory 511 stores the software 512 which may be processor-readable, processor-executable software code containing instructions that are configured to, when executed, cause the processor 510 to operate as a special purpose computer programmed to perform the various functions described herein. Alternatively, the software 512 may not be directly executable by the processor 510 but may be configured to cause the processor 510, e.g., when compiled and executed, to operate as a special purpose computer to perform the various functions described herein. The description may refer only to the processor 510 performing a function, but this includes other implementations such as where the processor 510 executes software and/or firmware. The description may refer to the processor 510 performing a function as shorthand for one or more of the processors contained in the processor 510 performing the function. The description may refer to the server 500 performing a function as shorthand for one or more appropriate components of the server 500 performing the function. The processor 510 may include a memory with stored instructions in addition to and/or instead of the memory 511. Functionality of the processor 510 is discussed more fully below.

The transceiver 515 may include a wireless transceiver 540 and a wired transceiver 550 configured to communicate with other devices through wireless connections and wired connections, respectively. For example, the wireless transceiver 540 may include a transmitter 542 and receiver 544 coupled to one or more antennas 546 for transmitting and/or receiving (e.g., on one or more uplink channels and/or one or more downlink channels) wireless signals 548 and transducing signals from the wireless signals 548 to wired (e.g., electrical and/or optical) signals and from wired (e.g., electrical and/or optical) signals to the wireless signals 548. The transmitter 542 may include multiple transmitters that may be discrete components or combined/integrated components, and/or the receiver 544 may include multiple receivers that may be discrete components or combined/integrated components. The wireless transceiver 540 may be configured to communicate signals (e.g., with the UE 300, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. The wired transceiver 550 may include a transmitter 552 and a receiver 554 configured for wired communication, e.g., to send communications to, and receive communications from, the base stations 102. The transmitter 552 may include multiple transmitters that may be discrete components or combined/integrated components, and/or the receiver 554 may include multiple receivers that may be discrete components or combined/integrated components. The wired transceiver 550 may be configured, e.g., for optical communication and/or electrical communication.

The configuration of the server 500 shown in FIG. 5 is an example and not limiting of the disclosure, including the claims, and other configurations may be used. For example, the description herein discusses that the server 500 is configured to perform or performs several functions, but one or more of these functions may be performed by the base station 400 and/or the UE 300.

The memory 511 may store software 512 that contains executable program code or software instructions that when executed by the processor 510 may cause the processor 510 to operate as a special purpose computer programmed to perform the functions disclosed herein. As illustrated, the memory 511 may include one or more components or modules that may be implemented by the processor 510 to perform the disclosed functions. While the components or modules are illustrated as software 512 in memory 511 that is executable by the processor 510, it should be understood that the components or modules may be stored in another computer readable medium or may be dedicated hardware either in the processor 510 or off the processor. A number of software modules and data tables may reside in the memory 511 and be utilized by the processor 510 in order to manage both communications and the functionality described herein. It should be appreciated that the organization of the contents of the memory 511 as shown is merely exemplary, and as such the functionality of the modules and/or data structures may be combined, separated, and/or be structured in different ways depending upon the implementation.

The memory 511, for example, may include an object feature report module 572 that when implemented by the one or more processors 510 configures the one or more processors 510 to receive, via the transceiver 515, an object feature report from a network node for one or more object features determined by the network node based on one or more non-RF measurements associated with an object of RF sensing. The object feature report, for example, may be received via RAT-dependent lower layer channels, such as PHY or MAC-CE channels, e.g., via PUSCH or PUCCH. The object features may be derived from measurements generated by non-RF sensors, which may include ultra-sound sensor, lidar, barometer, camera, or a combination thereof. The one or more processors 510 may be configured by the object feature report module 572 in memory 511 to determine the object features to be determined and to send to the network node an indication of object features of the object to be included in the object feature report, e.g., via the transceiver 515. For example, the one or more processors 510 may be configured to receive, via the transceiver 515, a capability message from the network node, such as a UE, indicating support for reporting different features for each different non-RF technology and may provide the indication of the object features to be reported in response. The one or more processors 510 may be further configured to send, via the transceiver 515, a request to the network node, or may receive a request from the network node, to prioritize object features.

The object features, for example, may be different for each non-RF sensor measurement used, e.g., including a range (e.g., distance from the network node), orientation (e.g., direction) with respect to the network node, estimated size, object class, atmospheric pressure, etc. Alternatively, the object feature report may include a common set of features for the different non-RF technologies, such as a radar cross section (RCS), e.g., including the RCS variance, speed, position, trajectory, and direction (with respect to the network node), etc. The object features in the object feature report may have a same format as used in RF sensing measurement reports.

The one or more processors 510 may be configured to generate RF sensing waveform and resources, including the Tx power per antenna, number of Tx antennas for radar reference signal transmission, radar reference repetition factor, based on the object features reported in the object feature report. The one or more processors 510 may be configured to send, via transceiver 515, the configured RF sensing waveform and resources to one or more network nodes for RF sending of the one or more objects in the environment.

While the object feature report module 572 is depicted as being software included in memory 511, the object feature report module 572 may be a hardware module, a software module, or a combination of hardware and software. For example, the module may include one or more application specific integrated circuits (ASICs), executable code, or a combination of both.

RF sensing, or radar systems, may include a monostatic radar system and a multistatic radar system. A monostatic radar system includes one device both transmitting the radar signals and receiving the reflections of the radar signals. A monostatic radar system may be for identifying a motion state of the transmitting/receiving device or for identifying an object in the transmitting/receiving device's environment. A multistatic radar system includes systems with a receiving device different than a transmitting device. For example, one or more transmitting devices transmit the radar signals, and one or more separate receiving devices receive reflections of the radar signals from an object. An example multistatic radar system is a bistatic radar system in which one transmitting device transmits and one receiving device receives, but any number of transmitting devices or receiving devices may exist. A multistatic radar system may be for identifying a motion state of the object reflecting the radar signals.

FIG. δ shows an example bistatic radar system 600. The bistatic radar system 600 includes a radar transmitter (RTX) 610 and a radar receiver (RRX) 620. The radar transmitter 610 and the radar receiver 620 are spatially separated by a baseline (L). In some implementations, the radar transmitter 610 may be one example of a base station 102 (or UE 104) and the radar receiver 620 may be an example of one of a different base station 102 (or UE 104) of FIG. 1.

The radar transmitter 610 is configured to transmit radar pulses 612 in a number of directions. Each of the pulses 612 may be a beamformed RF signal having a particular width and directionality. Objects or surfaces along the trajectory of any of the pulses 612 may cause the pulses 612 to reflect or scatter. Reflected pulses may be referred to as “echoes” of the pulses from which they originate. In the example of FIG. 6, a target object 601 is located along the path of one of the radar pulses 612. The radar pulse 612(i) incident on the target object 601 is reflected as an echo 622. As shown in FIG. 6, the echo 622 is reflected in the direction of the radar receiver 620. The radar receiver 620 may determine ranging information about the target object 601 based, at least in part, on the timing of the echo 622. Example ranging information may include, but is not limited to, a distance, direction, or velocity of the target object 601.

In some implementations, the radar receiver 620 may determine a distance (R_{R}) of the target object 601 relative to the radar receiver 620 based, at least in part, on the baseline distance L (between the radar transmitter 610 and the radar receiver 620), an angle of arrival (6R) of the echo 622, and a time of flight (τ) from the transmission of the incident pulse 612(i) by the radar transmitter 610 to the reception of the resulting echo 622 by the radar receiver 620. More specifically, the distance R_{R} can be calculated according to Equation 1.

$${R}_{R} = \frac{{( {R}_{T} + {R}_{R} )}^{2} - {L}^{2}}{2 ( {R}_{T} + {R}_{R} - L cos {θ}_{R} )} \qquad ( 1 )$$

where R_{T}+R_{R} represents the combined distances from the target object 601 to each of the radar transmitter 610 and the radar receiver 620. As shown in FIG. 6, R_{T}+R_{R} defines a range of distances 602 around the radar transmitter 610 and the radar receiver 620 (in the shape of an ellipse) in which the target object 601 may be located. More specifically, R_{T}+R_{R} can be calculated, according to Equation 2, as a function of the baseline (L), the time of flight of the reflected pulse (τ), and the propagation speed of the radar pulses (cₚ).

$${R}_{T} + {R}_{R} = {c}_{p} τ + L \qquad ( 2 )$$

With reference to Equations 1 and 2, the baseline L and propagation speed cₚ represent fixed or preconfigured values inherent to the radar system 600. The angle of arrival θ_{R} may be determined based on a time difference of arrival (TDOA) of the echo 622 between different receive antennas of the radar receiver 620 in an antenna array or based on the antenna sector (corresponding to a preset beam of a phased array antenna) used by the radar receiver 620 to receive the echo 622. However, to calculate the time of flight τ, the radar receiver 620 must have knowledge of the time at which the incident pulse 612(i) was transmitted at the position of the receiver. More specifically, the time of flight τcan be calculated, according to Equation 3, as a function of the time of transmission of the incident pulse (Tₚᵤₗₛₑ) and the time of reception of the echo (T_{echo}).

$$τ = {T}_{echo} - {T}_{pulse} \qquad ( 3 )$$

For a stationary radar transmitter 610 and stationary radar receiver 620, the target bistatic Doppler frequency is given by:

$${f}_{D} = \frac{2 v}{{c}_{p}} * cos δ * cos ( \frac{β}{2} ) \qquad ( 2 )$$

where v is the velocity of the target object 601, β is the difference between the angle of departure θ_{T} and the angle of arrival θ_{R}, and δ is the angle between the velocity vector v and the angle β.

Because the radar transmitter 610 and the radar receiver 620 are implemented in (or correspond to) separate wireless communication devices, the radar transmitter 610 may need to communicate the timing of the transmission of the incident pulse Tₚᵤₗₛₑ to the radar receiver 620. However, because the radar transmitter 610 transmits pulses 612 in a number of directions, the radar transmitter 610 may be unaware as to which of the pulses 612 is incident on the target object 601. Accordingly, the radar transmitter 610 may need to communicate the timing of each of the pulses 612 to the radar receiver 620, and the radar receiver 620 may need to determine which of the pulses 612 resulted in the echo 622. In some implementations, packet formats in accordance with IEEE 802.11 standards may be used to communicate such timing information (Tₚᵤₗₛₑ) from the radar transmitter 610 to the radar receiver 620.

In some implementations, the radar transmitter 610 may transmit timing information followed by a synchronization sequence (not shown for simplicity) to the radar receiver 620 prior to transmitting the radar pulses 612. The timing information can be used to synchronize a receiver clock of the radar receiver 620 with a transmit clock of the radar transmitter 610. For example, the timing information may indicate a timing offset or delay between one or more portions of the synchronization sequence and the beginning of the transmission of the radar pulses 612. Thus, upon detecting at least a portion of the synchronization sequence and the subsequent echo 622, the radar receiver 620 may determine the exact time at which the incident pulse 612(i) was transmitted by the radar transmitter 610. The radar receiver 620 may compare the timing of the echo T_{echo} with the timing of the transmitted pulse Tₚᵤₗₛₑ to determine the distance R_{R} of the target object 601 (such as described with respect to Equations 1-3).

In some implementations, the radar transmitter 610 also may determine ranging information regarding the target object 601. For example, the radar transmitter 610 may determine its relative distance R_{T} to the target object 601. For example, in some aspects, the radar receiver 620 may provide feedback regarding the echo 622 to the radar transmitter 610. The feedback may include the timing of the echo T_{echo}, the timing of the transmitted pulse Tₚᵤₗₛₑ, the time of flight τ, the angle of arrival θ_{R}, the calculated distance R_{R}, or any combination thereof. The radar transmitter 610 may then calculate the distance R_{T} of the target object 601 based, at least in part, on the angle of departure OT of the incident pulse 612(i). For example, the radar transmitter 610 may calculate the distance R_{T} by substituting the angle of departure θ_{T} for the angle of arrival θ_{R} in Equation 1. The radar transmitter 610 may determine the angle of departure θ_{T} based on the antenna sector (corresponding to a particular beam of a phased array antenna) used by the radar transmitter 610 to transmit the incident pulse 612(i).

By providing the RF sensing server 172 with object features of the target object 601 in an object feature report, the radar pulses 612 used for sensing the target object 601 may be specifically configured. For example, the waveform and resources, including the Tx power per antenna, number of Tx antennas for radar reference signal transmission, radar reference repetition factor, may be optimized based on the object features reported in the object feature report, including the range from the radar transmitter 610 and radar receiver 620 to the target object 601, the size of the target object 601, and atmospheric conditions. By specifically tailoring the configuration of the radar pulses 612 based on the object feature report, improvements in sensing performance, spectrum efficiency of the cellular systems and power efficiency of the sensing node are enabled.

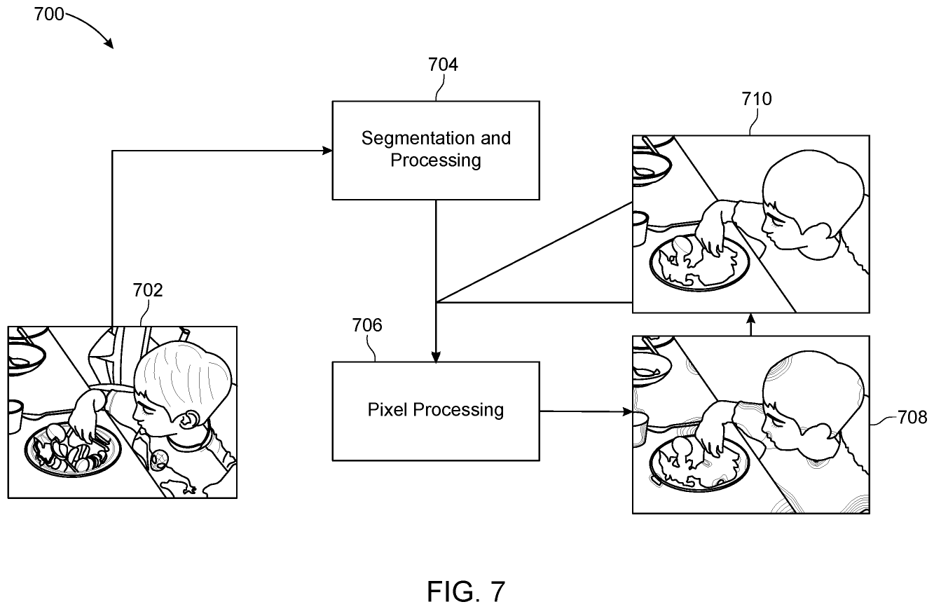

FIG. 7 is an example of a process 700 of obtaining object features from an image captured by a camera. It should be understood that the process 700 merely illustrates one example process to generate a category map from an image, which may be used to derive object features.

As illustrated, an image 702 may be captured with a camera, e.g., camera 318 in UE 300 or a camera in sensors 412 in the base station 400. The processor, e.g., processor 334 in UE 300 or processor 410 in base station 400, may scale the image, which is used for segmentation and processing 704. The segmented image and the input image may then undergo pixel processing 706 to generate a processed image 708. Additionally, category mapping may be performed using the segmentation from the segmentation and processing process 704 and the processed image 708 to generate a category map 710. The resulting category map 710 may be used to derive the object class in the image 702, e.g., human, car, bicycle, etc. Moreover, the orientation of the object (with respect to the camera) may be determined based on the orientation of the camera at the time the image is captured, e.g., as determined using a magnetometer and/or gyroscope. Further, the estimated size or radar cross section may be determined for the object in the image based on the spatial extent of the object in the image, along with the magnification of the lens used to capture the image, focal length, etc., as well as the average object size based on the object class.

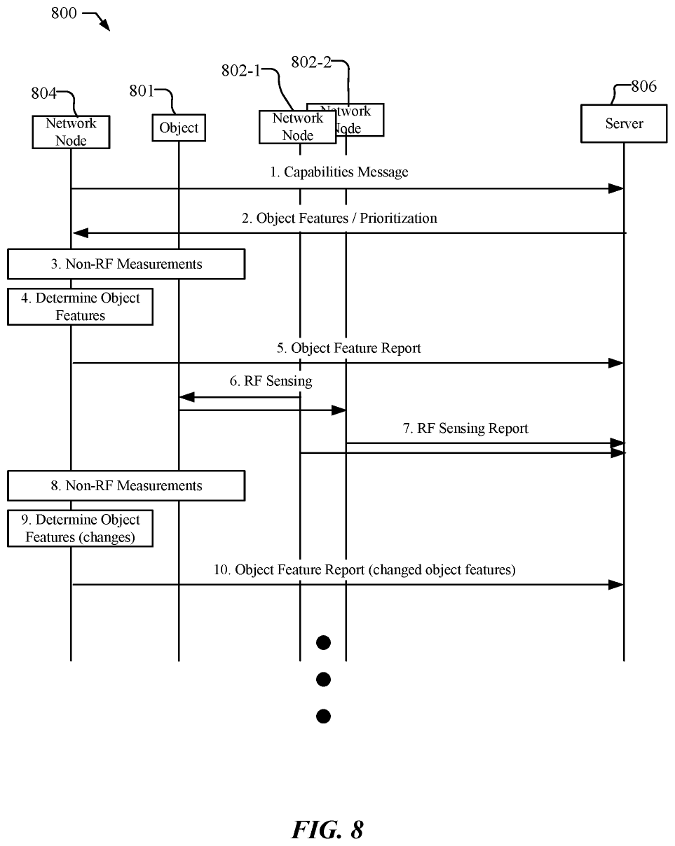

FIG. 8 is a message flow 800 illustrating the messaging between a network node 804 and a server 806 for the generation and transmission of object feature reports based on non-RF measurements for supporting RF sensing of a target object 801. The network node may be a UE, such as UE 104 or UE 300 shown in FIGS. 1 and 3, respectively, or a base station, such as base station 102 or 400 shown in FIGS. 1 and 4. The message flow 800 illustrates the presence of additional network nodes 802-1 and 802-2, both or either of which may be base stations 802 shown in FIG. 1 or base station 400 shown in FIG. 3, or the UE 104 shown in FIG. 1 or UE 300 shown in FIG. 3. The server 806, for example, may be the RF sensing server 172 shown in FIG. 1 or may be another entity coupled to or included in the wireless network. The procedure illustrated in FIG. 8 may be used in support of RF sensing, such as monostatic or bistatic radar sensing of the target object 801, e.g., as discussed above in reference to FIG. 6. It should be understood that FIG. 8 illustrates messages that may be transmitted in support of RF sensing but may not include all messages or actions performed during the RF sensing, and additionally include messages or actions that are provided for the sake of completeness, but may not be necessary for RF sensing.

At stage 1, the network node 804 may provide a capabilities message to the server 806, which may provide the capabilities of the network node 804 for generating object features using non-RF measurements. The capabilities, for example, may indicate which non-RF sensors are available for generating measurements of an object, and/or types of object features that the network node 804 may derive. The capabilities message provided in stage 1 may be sent in response to a request for capabilities previously sent to the network node 804 by the server 806.

At stage 2, the server 806 may send a message to the network node providing an indication of object features to be reported and prioritization to be used, if any. For example, the server 806 may indicate the types of object features to be reported, such as the object feature for each available non-RF sensor, such as object class, estimated size, motion status, orientation, position, atmospheric pressure, etc., or an identification of a common set of object features for all non-RF sensor measurements that are to be reported, such as RCS, RCS variance, speed, position, trajectory, direction, atmospheric pressure, etc. The server 806 may further request that the network node prioritize object feature reports and may indicate priority rules to be used for object feature derivation and reporting for the target object 801, such as object features that may be given a higher priority than other object features, or an identification of objects (assuming there are multiple objects) that are to be given a higher priority than other objects. In some implementations, the network node 804 may send a request to the server 806 requesting prioritization of the object feature report. In some implementations, the server 806 may provide an indication of object IDs to be used for the target object 801 that is to be associated with object features reported by the network node 804. The server 806 may further provide an indication of a report period to be used by the network node 804 for reporting object features, and indication of whether a report of an object feature may be skipped if there are no update for the object feature (e.g., the changes from the last report are less than a predetermined threshold), as well as the number of reports that may be skipped.

At stage 3, the network node 804 may obtain non-RF sensor measurements associated with the target object 801. For example, the network node may capture an image of the 801 and/or may probe the target object 801 using lidar, ultra-sound, or other non-RF sensors. The network node 804 may further obtain atmospheric pressure measurements, e.g., with a barometer. The network node 804 may determine its orientation, e.g., with respect to the geographic coordinate system (GCS) or other coordinate system, using magnetometers, gyroscopes, accelerometers, etc., at or near the time of obtaining non-RF sensor measurements associated with the target object 801. The network node 804 may additionally determine its position, e.g., with respect to the geographic coordinate system (GCS) or other coordinate system, using GNSS, cellular positioning, etc., at or near the time of obtaining non-RF sensor measurements associated with the target object 801.

At stage 4, the network node 804 derives object features from the non-RF sensor measurements obtained in stage 3. The object features that are derived, for example, may be in accordance with the indication of object features provided by the server 806 in stage 2. For example, object features derived from a camera may be the object class (e.g., human, car, bicycle, dog, cat, etc.), the estimated size, the motion status of the object, and orientation (e.g., direction) with respect to the network node 804. Object features derived from a lidar and/or ultra-sound may be a range (e.g., distance from the network node 804), orientation (e.g., direction) with respect to the network node 804, estimated size, and object class. Object features derived from a barometric sensor may include the atmospheric pressure. In another implementation, a common set of features may be determined for the non-RF sensor measurements, such as the radar cross section (RCS), e.g., including the RCS variance, speed, position, trajectory, direction (e.g., angle with respect to the network node 804, or any combination thereof. Additional or different object features may be derived, as well, if desired. In some implementations, the object features derived by the network node 804 may be prioritized, i.e., not all possible object features may be derived, e.g., based on priority rules, which may be obtained from the server 806 in stage 2 or stored in network node 804.

At stage 5, the network node 804 sends an object feature report to the server 806. The object feature report may include the object features derived stage 4. It should be understood that the server 806 may obtain object feature reports for the target object 801 from multiple network nodes (not shown). In some implementations, the format of the object features in the object feature report may be the same as that used in a report for RF sensing measurements, e.g., sent in stage 7. If the network node 804 is the UE 104 (or UE 300), the object feature report may be wireless transmitted using a RAT-dependent lower layer channel, such as PHY or MAC-CE channels, and may be transmitted via PUSCH or PUCCH. It should be understood that the object feature report may be sent to the server 806 via a serving base station (e.g., network node 802-1). The object feature report may include all of the derived object features or may report a subset of the derived object features, e.g., based on priority rules, which may be obtained from the server 806 in stage 2 or stored in network node 804. The object feature report may include one or more time stamps. For example, the object feature report may include a single time stamp associated with all of the reported object features, or time stamps associated with the non-RF sensor measurement used to derive each object feature. The object feature report may include an object ID for the target object 801 associated with the reported object features. The object ID may be obtained from the server 806, e.g., in stage 6, or may be defined by the network node 804 and provided to the server 806 (e.g., in the object feature report in stage 5). The object feature report may further provide an indication of the report period, e.g., identify the period from any previous report (if any).

At stage 6, RF sensing of the target object 801 may be performed by one or more network nodes, illustrated as network nodes 802-1 and 802-2 in FIG. 8. In some implementations, the RF sensing of the target object 801 may include network node 804. The RF sensing in stage 6, for example, may be similar to that shown in FIG. 6. In some implementations, the RF sensing of the target object 801 may be performed by network nodes 802 using waveforms and RRS resources configured by the server 806 based on the object feature report obtained at stage 5 and provided to the network nodes 802.

At stage 7, the network nodes 802 (e.g., one or both of the network nodes 802-1, 802-2) may send an RF sensing report to the server 806.

At stage 8, the network node 804 may obtain another set of non-RF sensor measurements associated with the target object 801, e.g., if the network node 804 is to provide multiple or periodic object feature reports. The non-RF sensor measurements associated with the target object 801 obtained in stage 8 may be the same or similar to those obtained in stage 3 discussed above.

At stage 9, the network node 804 derives object features from the non-RF sensor measurements obtained in stage 8. The object features derived in stage 9 may be the same or similar to those derived in stage 4 discussed above. In some implementations, different non-RF sensor measurements may be obtained and/or different object features derived based on prioritization, e.g., using priority rules obtained from the server 806 in stage 2 or stored in network node 804. The network node 804 may determine if the object features derived in stage 9 are significantly different than those derived in stage 4 (and reported in stage 5), e.g., if the changes are greater than a predetermined threshold.

At stage 10, the network node 804 sends an object feature report to the server 806. The object feature report in stage 10 may be the same or similar to the object feature report in stage 5 discussed above. The object feature report in stage 10, however, may include only object features that are significantly different than previously reported object features as determined in stage 9. The server 806 may presume that any object feature that is not updated in the object feature report in stage 10 has not changed.

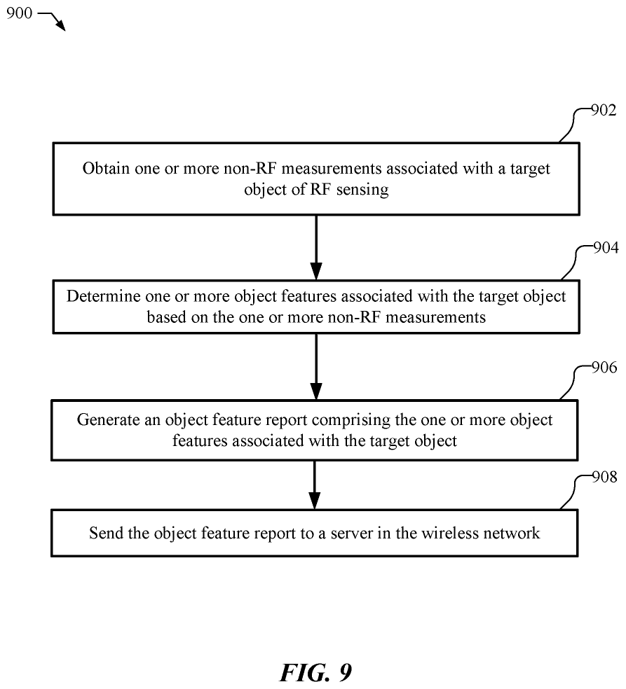

FIG. 9 shows a flowchart for an exemplary process 900 for supporting radio frequency (RF) sensing in a wireless network, which may be performed by a network node, such as network node 804 illustrated in FIG. 8, which may be, e.g., the UE 104 or UE 300 shown in FIGS. 1 and 3 or a base station 102 or base station 400 shown in FIG. 1 or 4, and in a manner consistent with disclosed implementations.

At block 902, the network node obtains one or more non-RF measurements associated with a target object of RF sensing, e.g., as discussed in reference to stages 3 and 8 of FIG. 8. In one implementation, the one or more non-RF measurements may include measurements performed by one or more of a camera, ultra-sound sensor, lidar, and barometer. A means for obtaining one or more non-RF measurements associated with a target object of RF sensing may include, e.g., one or more of sensor(s) 313, camera 318, and one or more processors 310 with dedicated hardware or implementing executable code or software instructions in memory 311 in UE 300, such as the object feature report module 372, shown in FIG. 3, or the one or more of sensor(s) 412 and one or more processors 410 with dedicated hardware or implementing executable code or software instructions in memory 413 in base station 400, such as the object feature report module 472, shown in FIG. 4.

At block 904, the network node determines one or more object features associated with the target object based on the one or more non-RF measurements, e.g., as discussed in reference to stages 4 and 9 of FIG. 8. In one implementation, the network node may determine the one or more object features by determining different object features for each different non-RF sensor used for the one or more non-RF measurements. In one implementation, the network node may determine the one or more object features by determining a common set of object feature for different non-RF technologies used for the one or more non-RF measurements. The common set of object feature, for example, may include one or more of radar cross section, radar cross section variance, speed, position, trajectory, direction, or a combination thereof. A means for determining one or more object features associated with the target object based on the one or more non-RF measurements may include, e.g., one or more of sensor(s) 313, camera 318, and one or more processors 310 with dedicated hardware or implementing executable code or software instructions in memory 311 in UE 300, such as the object feature report module 372, shown in FIG. 3, or the one or more of sensor(s) 412 and one or more processors 410 with dedicated hardware or implementing executable code or software instructions in memory 413 in base station 400, such as the object feature report module 472, shown in FIG. 4.

At block 906, network node generates an object feature report comprising the one or more object features associated with the target object, e.g., as discussed in reference to stages 5 and 10 of FIG. 8. In one implementation, the object feature report may further include a time stamp associated with the one or more non-RF measurements. In one implementation, the object feature report may further include an object identity (ID) associated with each object feature. In one implementation, the object feature report may further include in indication of a report period. A means for generating an object feature report comprising the one or more object features associated with the target object may include, e.g., the one or more processors 310 with dedicated hardware or implementing executable code or software instructions in memory 311 in UE 300, such as the object feature report module 372, shown in FIG. 3, or the one or more processors 410 with dedicated hardware or implementing executable code or software instructions in memory 413 in base station 400, such as the object feature report module 472, shown in FIG. 4.

At block 908, the network node sends the object feature report to a server in the wireless network, e.g., as discussed in reference to stages 5 and 10 of FIG. 8. A means for sending the object feature report to a server in the wireless network may include, e.g., the transceiver 315 and one or more processors 310 with dedicated hardware or implementing executable code or software instructions in memory 311 in UE 300, such as the object feature report module 372, shown in FIG. 3, or the transceiver 415 and one or more processors 410 with dedicated hardware or implementing executable code or software instructions in memory 413 in base station 400, such as the object feature report module 472, shown in FIG. 4.

In one implementation, the network node may send a capability message to the server indicating support for object feature reporting, e.g., as discussed in reference to stage 1 of FIG. 8. A means for sending a capability message to the server indicating support for object feature reporting may include, e.g., the transceiver 315 and one or more processors 310 with dedicated hardware or implementing executable code or software instructions in memory 311 in UE 300, such as the object feature report module 372, shown in FIG. 3, or the transceiver 415 and one or more processors 410 with dedicated hardware or implementing executable code or software instructions in memory 413 in base station 400, such as the object feature report module 472, shown in FIG. 4. In some implementations, the network node may receive an indication of object features to be included in the object feature report, e.g., as discussed in reference to stage 1 of FIG. 8. A means for receiving an indication of object features to be included in the object feature report may include, e.g., the transceiver 315 and one or more processors 310 with dedicated hardware or implementing executable code or software instructions in memory 311 in UE 300, such as the object feature report module 372, shown in FIG. 3, or the transceiver 415 and one or more processors 410 with dedicated hardware or implementing executable code or software instructions in memory 413 in base station 400, such as the object feature report module 472, shown in FIG. 4. In some implementations, the network node may receive an indication of object features to be included in the object feature report, e.g., as discussed in reference to stage 1 of FIG. 8.

In one implementation, the network node may prioritize the object feature report over another object feature report, e.g., as discussed in reference to stages 4, 5 and 9, 10 of FIG. 8. In one implementation, the prioritization of the object feature report may be requested by the server or requested by the network node, e.g., as discussed in reference to stage 2 of FIG. 8. A means for prioritizing the object feature report over another object feature report may include, e.g., the transceiver 315 and one or more processors 310 with dedicated hardware or implementing executable code or software instructions in memory 311 in UE 300, such as the object feature report module 372, shown in FIG. 3, or the transceiver 415 and one or more processors 410 with dedicated hardware or implementing executable code or software instructions in memory 413 in base station 400, such as the object feature report module 472, shown in FIG. 4.

In one implementation, the network node may obtain a subsequent set of one or more non-RF measurements associated with the target object of RF sensing, e.g., as discussed in reference to stages 8 of FIG. 8. A means for obtaining a subsequent set of one or more non-RF measurements associated with the target object of RF sensing may include, e.g., one or more of sensor(s) 313, camera 318, and one or more processors 310 with dedicated hardware or implementing executable code or software instructions in memory 311 in UE 300, such as the object feature report module 372, shown in FIG. 3, or the one or more of sensor(s) 412 and one or more processors 410 with dedicated hardware or implementing executable code or software instructions in memory 413 in base station 400, such as the object feature report module 472, shown in FIG. 4. The network node may further determine a change in one or more object features determined from the subsequent set of the one or more non-RF measurements with respect to the one or more object features in the object feature report is less than a threshold, e.g., as discussed in reference to stage 9 of FIG. 8. A means for determining a change in one or more object features determined from the subsequent set of the one or more non-RF measurements with respect to the one or more object features in the object feature report is less than a threshold may include, e.g., one or more of sensor(s) 313, camera 318, and one or more processors 310 with dedicated hardware or implementing executable code or software instructions in memory 311 in UE 300, such as the object feature report module 372, shown in FIG. 3, or the one or more of sensor(s) 412 and one or more processors 410 with dedicated hardware or implementing executable code or software instructions in memory 413 in base station 400, such as the object feature report module 472, shown in FIG. 4. The network node may not report the one or more object features, e.g., as discussed in stage 10 of FIG. 8. A means for not reporting the one or more object features may include, e.g., the transceiver 315 and one or more processors 310 with dedicated hardware or implementing executable code or software instructions in memory 311 in UE 300, such as the object feature report module 372, shown in FIG. 3, or the transceiver 415 and one or more processors 410 with dedicated hardware or implementing executable code or software instructions in memory 413 in base station 400, such as the object feature report module 472, shown in FIG. 4.

In one implementation, the object feature report may have a format for object features that is used in an RF sensing measurement report for the target object sent to the server, e.g., as discussed in stages 5 and 10 of FIG. 8.

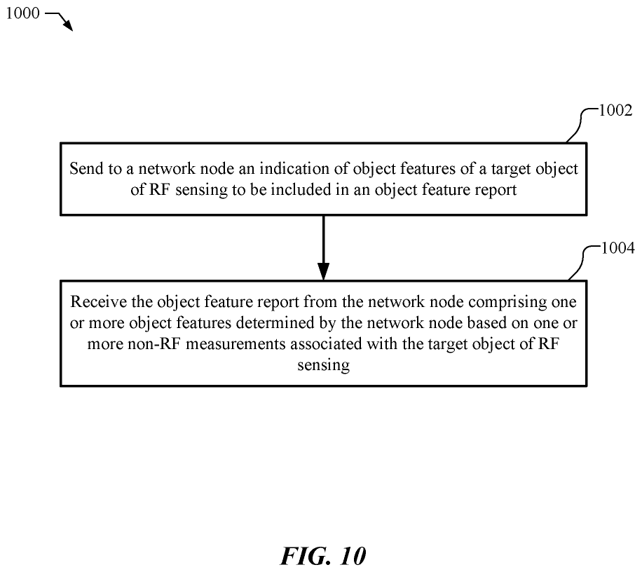

FIG. 10 shows a flowchart for an exemplary process 1000 for supporting radio frequency (RF) sensing in a wireless network, which may be performed by a server, such as server 806 illustrated in FIG. 8, which may be the RF sensing server 172 shown in FIG. 1 or server 500 shown in FIG. 5, and in a manner consistent with disclosed implementations.

At block 1002, the server sends to a network node an indication of object features of a target object of RF sensing to be included in an object feature report, e.g., as discussed in reference to stage 2 of FIG. 8. A means for sending to a network node an indication of object features of a target object of RF sensing to be included in an object feature report may include, e.g., the transceiver 515 and one or more processors 510 with dedicated hardware or implementing executable code or software instructions in memory 511 in server 500, such as the object feature report module 572, shown in FIG. 5.

At block 1004, the server receives the object feature report from the network node comprising one or more object features determined by the network node based on one or more non-RF measurements associated with the target object of RF sensing, e.g., as discussed in reference to stages 5 and 10 of FIG. 8. In one implementation, the one or more non-RF measurements may include measurements performed by one or more of a camera, ultra-sound sensor, lidar, and barometer. A means for receiving the object feature report from the network node comprising one or more object features determined by the network node based on one or more non-RF measurements associated with the target object of RF sensing may include, e.g., the transceiver 515 and one or more processors 510 with dedicated hardware or implementing executable code or software instructions in memory 511 in server 500, such as the object feature report module 572, shown in FIG. 5.

In one implementation, the server may receive a capability message from the UE network node indicating support for object feature reporting, e.g., as discussed in reference to stage 1 of FIG. 8. A means for receiving a capability message from the UE network node indicating support for object feature reporting may include, e.g., the transceiver 515 and one or more processors 510 with dedicated hardware or implementing executable code or software instructions in memory 511 in server 500, such as the object feature report module 572, shown in FIG. 5.

In one implementation, the object feature report may include different features for each different non-RF sensor used to generate the one or more non-RF measurements, e.g., as discussed in reference to stages 5 and 10 of FIG. 8. In one implementation, the object feature report may include a common set of features reported for different non-RF sensors used to generate the one or more non-RF measurements, e.g., as discussed in reference to stages 5 and 10 of FIG. 8. For example, the common set of features for the target object may include one or more of radar cross section, radar cross section variance, speed, position, trajectory, direction, or a combination thereof, e.g., as discussed in reference to stages 5 and 10 of FIG. 8.

In one implementation, the object feature report may further include a time stamp associated with the one or more non-RF measurements, e.g., as discussed in reference to stages 5 and 10 of FIG. 8.

In one implementation, the object feature report may further include an object identity (ID) associated with each feature, e.g., as discussed in reference to stages 5 and 10 of FIG. 8.

In one implementation, the object feature report may further include an indication of a report period, e.g., as discussed in reference to stages 5 and 10 of FIG. 8.

In one implementation, the server may send a request to the network node or receiving a request from the network node to prioritize object features for the target object, e.g., as discussed in reference to stage 2 of FIG. 8. A means for sending a request to the network node or receiving a request from the network node to prioritize object features for the target object may include, e.g., the transceiver 515 and one or more processors 510 with dedicated hardware or implementing executable code or software instructions in memory 511 in server 500, such as the object feature report module 572, shown in FIG. 5.

In one implementation, the object feature reports are received periodically from the network node, and the server may determine there is no update to one or more object features that are not received in a report period, e.g., as discussed in reference to stage 10 of FIG. 8.

In one implementation, the server may receive a report for RF sensing measurements of the target object, wherein the object feature report has a format for object features that is used in a received RF sensing measurement report for the target object, e.g., as discussed at stages 5 and 10 of FIG. 8.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

In view of this description embodiments may include different combinations of features. Implementation examples are described in the following numbered clauses:
Clause 1. A method performed by a network node in a wireless network for supporting radio frequency (RF) sensing in the wireless network comprising: obtaining one or more non-RF measurements associated with a target object of RF sensing; determining one or more object features associated with the target object based on the one or more non-RF measurements; generating an object feature report comprising the one or more object features associated with the target object; and sending the object feature report to a server in the wireless network.
Clause 2. The method of clause 1, wherein the one or more non-RF measurements comprises measurements performed by one or more of a camera, ultra-sound sensor, lidar, and barometer.
Clause 3. The method of any of clauses 1-2, further comprising sending a capability message to the server indicating support for object feature reporting.
Clause 4. The method of clause 3, further comprising receiving an indication of object features to be included in the object feature report.
Clause 5. The method of any of clauses 1-4, wherein determining the one or more object features comprises determining different object features for each different non-RF sensor used for the one or more non-RF measurements.
Clause 6. The method of any of clauses 1-4, wherein determining the one or more object features comprises determining a common set of object feature for different non-RF technologies used for the one or more non-RF measurements.
Clause 7. The method of clause 6, wherein the common set of object feature comprises one or more of radar cross section, radar cross section variance, speed, position, trajectory, direction, or a combination thereof.
Clause 8. The method of any of clauses 1-7, wherein the object feature report further comprises a time stamp associated with the one or more non-RF measurements.
Clause 9. The method of any of clauses 1-8, wherein the object feature report further comprises an object identity (ID) associated with each object feature.
Clause 10. The method of any of clauses 1-9, wherein the object feature report further comprises in indication of a report period.
Clause 11. The method of any of clauses 1-10, further comprising prioritizing the object feature report over another object feature report.
Clause 12. The method of clause 11, wherein prioritization of the object feature report is dynamically requested by the server or requested by the network node.
Clause 13. The method of any of clauses 1-11, further comprising: obtaining a subsequent set of one or more non-RF measurements associated with the target object of RF sensing; determining a change in one or more object features determined from the subsequent set of the one or more non-RF measurements with respect to the one or more object features in the object feature report is less than a threshold; and not reporting the one or more object features.
Clause 14. The method of any of clauses 1-13, wherein the object feature report has a format for object features that is used in an RF sensing measurement report for the target object sent to the server.
Clause 15. A network node in a wireless network configured for supporting radio frequency (RF) sensing in the wireless network, comprising: at least one transceiver; one or more non-RF sensors; at least one memory; and at least one processor coupled to the at least one transceiver, the one or more non-RF sensors, and the at least one memory, wherein the at least one processor is configured to cause the network node to: obtain, from the one or more non-RF sensors, one or more non-RF measurements associated with a target object of RF sensing; determine one or more object features associated with the target object based on the one or more non-RF measurements; generate an object feature report comprising the one or more object features associated with the target object; and send, via the at least one transceiver, the object feature report to a server in the wireless network.
Clause 16. The network node of clause 15, wherein the one or more non-RF sensors comprise one or more of a camera, ultra-sound sensor, lidar, and barometer.
Clause 17. The network node of any of clauses 15-16 wherein the at least one processor is further configured to send, via the at least one transceiver, a capability message to the server indicating support for object feature reporting.
Clause 18. The network node of clause 17, wherein the at least one processor is further configured to receive, via the at least one transceiver, an indication of object features to be included in the object feature report.
Clause 19. The network node of any of clauses 15-18, wherein the at least one processor is configured to determine the one or more object features by being configured to determine different object features for each different non-RF sensor used for the one or more non-RF measurements.
Clause 20. The network node of any of clauses 15-18, wherein the at least one processor is configured to determine the one or more object features by being configured to a common set of object feature for different non-RF technologies used for the one or more non-RF measurements.
Clause 21. The network node of clause 20, wherein the common set of object feature comprises one or more of radar cross section, radar cross section variance, speed, position, trajectory, direction, or a combination thereof.
Clause 22. The network node of any of clauses 15-21, wherein the object feature report further comprises a time stamp associated with the one or more non-RF measurements.
Clause 23. The network node of any of clauses 15-22, wherein the object feature report further comprises an object identity (ID) associated with each object feature.
Clause 24. The network node of any of clauses 15-23, wherein the object feature report further comprises in indication of a report period.
Clause 25. The network node of any of clauses 15-24, wherein the at least one processor is further configured to prioritize the object feature report over another object feature report.
Clause 26. The network node of any of clauses 15-25, wherein prioritization of the object feature report is dynamically requested by the server or requested by the network node.
Clause 27. The network node of any of clauses 15-26, wherein the at least one processor is further configured to: obtain, from the one or more non-RF sensors, a subsequent set of one or more non-RF measurements associated with the target object of RF sensing; determine a change in one or more object features determined from the subsequent set of the one or more non-RF measurements with respect to the one or more object features in the object feature report is less than a threshold; and not report the one or more object features.
Clause 28. The network node of any of clauses 15-27, wherein the object feature report has a format for object features that is used in an RF sensing measurement report for the target object sent to the server.
Clause 29. A network node in a wireless network configured for supporting radio frequency (RF) sensing in the wireless network, comprising: means for obtaining one or more non-RF measurements associated with a target object of RF sensing; means for determining one or more object features associated with the target object based on the one or more non-RF measurements; means for generating an object feature report comprising the one or more object features associated with the target object; and means for sending the object feature report to a server in the wireless network.
Clause 30. The network node of clause 29, wherein the one or more non-RF measurements comprises measurements performed by one or more of a camera, ultra-sound sensor, lidar, and barometer.
Clause 31. The network node of any of clauses 29-30 further comprising means for sending a capability message to the server indicating support for object feature reporting.
Clause 32. The network node of clause 31, further comprising means for receiving an indication of object features to be included in the object feature report.
Clause 33. The network node of any of clauses 29-32, wherein the means for determining the one or more object features determines different object features for each different non-RF sensor used for the one or more non-RF measurements.
Clause 34. The network node of any of clauses 29-32, wherein the means for determining the one or more object features determines a common set of object feature for different non-RF technologies used for the one or more non-RF measurements.
Clause 35. The network node of clause 34, wherein the common set of object feature comprises one or more of radar cross section, radar cross section variance, speed, position, trajectory, direction, or a combination thereof.
Clause 36. The network node of any of clauses 29-35, wherein the object feature report further comprises a time stamp associated with the one or more non-RF measurements.
Clause 37. The network node of any of clauses 29-36, wherein the object feature report further comprises an object identity (ID) associated with each object feature.
Clause 38. The network node of any of clauses 29-37, wherein the object feature report further comprises in indication of a report period.
Clause 39. The network node of any of clauses 29-38, further comprising means for prioritizing the object feature report over another object feature report.
Clause 40. The network node of any of clauses 29-39, wherein prioritization of the object feature report is dynamically requested by the server or requested by the network node.
Clause 41. The network node of any of clauses 29-40, further comprising: means for obtaining a subsequent set of one or more non-RF measurements associated with the target object of RF sensing; means for determining a change in one or more object features determined from the subsequent set of the one or more non-RF measurements with respect to the one or more object features in the object feature report is less than a threshold; and means for not reporting the one or more object features.
Clause 42. The network node of any of clauses 29-41, wherein the object feature report has a format for object features that is used in an RF sensing measurement report for the target object sent to the server.
Clause 43. A non-transitory computer-readable storage medium including program code stored thereon, the program code is operable to configure at least one processor in a network node in a wireless network for supporting radio frequency (RF) sensing in the wireless network, the program code comprising instructions to: obtain one or more non-RF measurements associated with a target object of RF sensing; determine one or more object features associated with the target object based on the one or more non-RF measurements; generate an object feature report comprising the one or more object features associated with the target object; and send the object feature report to a server in the wireless network.
Clause 44. The non-transitory computer-readable storage medium of clause 43, wherein the one or more non-RF measurements comprises measurements performed by one or more of a camera, ultra-sound sensor, lidar, and barometer.
Clause 45. The non-transitory computer-readable storage medium of any of clauses 43-44 wherein the program code further comprises instructions to send a capability message to the server indicating support for object feature reporting.
Clause 46. The non-transitory computer-readable storage medium of clause 45, wherein the program code further comprises instructions to receive an indication of object features to be included in the object feature report.
Clause 47. The non-transitory computer-readable storage medium of any of clauses 43-46, wherein instructions to determine the one or more object features comprise instructions to determine different object features for each different non-RF sensor used for the one or more non-RF measurements.
Clause 48. The non-transitory computer-readable storage medium of any of clauses 43-46, wherein the instructions to determine the one or more object features comprise instructions to a common set of object feature for different non-RF technologies used for the one or more non-RF measurements.
Clause 49. The non-transitory computer-readable storage medium of clause 48, wherein the common set of object feature comprises one or more of radar cross section, radar cross section variance, speed, position, trajectory, direction, or a combination thereof.
Clause 50. The non-transitory computer-readable storage medium of any of clauses 43-49, wherein the object feature report further comprises a time stamp associated with the one or more non-RF measurements.
Clause 51. The non-transitory computer-readable storage medium of any of clauses 43-50, wherein the object feature report further comprises an object identity (ID) associated with each object feature.
Clause 52. The non-transitory computer-readable storage medium of any of clauses 43-51, wherein the object feature report further comprises in indication of a report period.
Clause 53. The non-transitory computer-readable storage medium of any of clauses 43-52, wherein the program code further comprises instructions to prioritize the object feature report over another object feature report.
Clause 54. The non-transitory computer-readable storage medium of any of clauses 43-53, wherein prioritization of the object feature report is dynamically requested by the server or requested by the network node.
Clause 55. The non-transitory computer-readable storage medium of any of clauses 43-54, wherein the program code further comprises instructions to: obtain a subsequent set of one or more non-RF measurements associated with the target object of RF sensing; determine a change in one or more object features determined from the subsequent set of the one or more non-RF measurements with respect to the one or more object features in the object feature report is less than a threshold; and not report the one or more object features.
Clause 56. The non-transitory computer-readable storage medium of any of clauses 43-55, wherein the object feature report has a format for object features that is used in an RF sensing measurement report for the target object sent to the server.
Clause 57. A method performed by a server in a wireless network for supporting radio frequency (RF) sensing in the wireless network comprising: sending to a network node an indication of object features of a target object of RF sensing to be included in an object feature report; and receiving the object feature report from the network node comprising one or more object features determined by the network node based on one or more non-RF measurements associated with the target object of RF sensing.
Clause 58. The method of clause 57, wherein the one or more non-RF measurements comprises measurements performed by one or more of a camera, ultra-sound sensor, lidar, and barometer.
Clause 59. The method of any of clauses 57-58, further comprising receiving a capability message from the network node indicating support for object feature reporting.
Clause 60. The method of any of clauses 57-59, wherein the object feature report comprises different features for each different non-RF sensor used to generate the one or more non-RF measurements.
Clause 61. The method of any of clauses 57-59, wherein the object feature report comprises a common set of features reported for different non-RF sensors used to generate the one or more non-RF measurements.
Clause 62. The method of clause 61, wherein the common set of features for the target object comprises one or more of radar cross section, radar cross section variance, speed, position, trajectory, direction, or a combination thereof.
Clause 63. The method of any of clauses 57-62, wherein the object feature report further comprises a time stamp associated with the one or more non-RF measurements.
Clause 64. The method of any of clauses 57-63, wherein the object feature report further comprises an object identity (ID) associated with each feature.
Clause 65. The method of any of clauses 57-64, wherein the object feature report further comprises an indication of a report period.
Clause 66. The method of any of clauses 57-65, further comprising sending a request to the network node or receiving a request from the network node to prioritize object features for the target object.
Clause 67. The method of any of clauses 57-66, wherein object feature reports are received periodically from the network node, determining there is no update to one or more object features that are not received in a report period.
Clause 68. The method of any of clauses 57-67, wherein the object feature report has a format for object features that is used in a received RF sensing measurement report for the target object.
Clause 69. A server in a wireless network configured for supporting radio frequency (RF) sensing in the wireless network comprising: at least one transceiver; at least one memory; and at least one processor coupled to the at least one transceiver, and the at least one memory, wherein the at least one processor is configured to cause the server to: send, via the at least one transceiver, to a network node an indication of object features of a target object of RF sensing to be included in an object feature report; and receive, via the at least one transceiver, the object feature report from the network node comprising one or more object features determined by the network node based on one or more non-RF measurements associated with the target object of RF sensing.
Clause 70. The server of clause 69, wherein the one or more non-RF measurements comprises measurements performed by one or more of a camera, ultra-sound sensor, lidar, and barometer.
Clause 71. The server of any of clauses 69-70, wherein the at least one processor is further configured to receive, via the at least one transceiver, a capability message from the network node indicating support for object feature reporting.
Clause 72. The server of any of clauses 69-71, wherein the object feature report comprises different features for each different non-RF sensor used to generate the one or more non-RF measurements.
Clause 73. The server of any of clauses 69-71, wherein the object feature report comprises a common set of features reported for different non-RF sensors used to generate the one or more non-RF measurements.
Clause 74. The server of clause 73, wherein the common set of features for the target object comprises one or more of radar cross section, radar cross section variance, speed, position, trajectory, direction, or a combination thereof.
Clause 75. The server of any of clauses 69-74, wherein the object feature report further comprises a time stamp associated with the one or more non-RF measurements.
Clause 76. The server of any of clauses 69-75, wherein the object feature report further comprises an object identity (ID) associated with each feature.
Clause 77. The server of any of clauses 69-76, wherein the object feature report further comprises an indication of a report period.
Clause 78. The server of any of clauses 69-77, wherein the at least one processor is further configured to send, via the at least one transceiver, a request to the network node or receiving a request from the network node to prioritize object features for the target object.
Clause 79. The server of any of clauses 69-78, wherein object feature reports are received periodically from the network node, determining there is no update to one or more object features that are not received in a report period.
Clause 80. The server of any of clauses 69-79, wherein the object feature report has a format for object features that is used in a received RF sensing measurement report for the target object.
Clause 81. A server in a wireless network configured for supporting radio frequency (RF) sensing in the wireless network comprising: means for sending to a network node an indication of object features of a target object of RF sensing to be included in an object feature report; and means for receiving the object feature report from the network node comprising one or more object features determined by the network node based on one or more non-RF measurements associated with the target object of RF sensing.
Clause 82. The server of clause 81, wherein the one or more non-RF measurements comprises measurements performed by one or more of a camera, ultra-sound sensor, lidar, and barometer.
Clause 83. The server of any of clauses 81-82, further comprising means for receiving a capability message from the network node indicating support for object feature reporting.
Clause 84. The server of any of clauses 81-83, wherein the object feature report comprises different features for each different non-RF sensor used to generate the one or more non-RF measurements.
Clause 85. The server of any of clauses 81-83, wherein the object feature report comprises a common set of features reported for different non-RF sensors used to generate the one or more non-RF measurements.
Clause 86. The server of clause 85, wherein the common set of features for the target object comprises one or more of radar cross section, radar cross section variance, speed, position, trajectory, direction, or a combination thereof.
Clause 87. The server of any of clauses 81-86, wherein the object feature report further comprises a time stamp associated with the one or more non-RF measurements.
Clause 88. The server of any of clauses 81-87, wherein the object feature report further comprises an object identity (ID) associated with each feature.
Clause 89. The server of any of clauses 81-88, wherein the object feature report further comprises an indication of a report period.
Clause 90. The server of any of clauses 81-89, further comprising means for sending a request to the network node or receiving a request from the network node to prioritize object features for the target object.
Clause 91. The server of any of clauses 81-90, wherein object feature reports are received periodically from the network node, determining there is no update to one or more object features that are not received in a report period.
Clause 92. The server of any of clauses 81-91, wherein the object feature report has a format for object features that is used in a received RF sensing measurement report for the target object.
Clause 93. A non-transitory computer-readable storage medium including program code stored thereon, the program code is operable to configure at least one processor in a server in a wireless network for supporting radio frequency (RF) sensing in the wireless network, the program code comprising instructions to: send to a network node an indication of object features of a target object of RF sensing to be included in an object feature report; and receive the object feature report from the network node comprising one or more object features determined by the network node based on one or more non-RF measurements associated with the target object of RF sensing.
Clause 94. The non-transitory computer-readable storage medium of clause 93, wherein the one or more non-RF measurements comprises measurements performed by one or more of a camera, ultra-sound sensor, lidar, and barometer.
Clause 95. The non-transitory computer-readable storage medium of any of clauses 93-94, wherein the program code further comprises instructions to receive a capability message from the network node indicating support for object feature reporting.
Clause 96. The non-transitory computer-readable storage medium of any of clauses 93-95, wherein the object feature report comprises different features for each different non-RF sensor used to generate the one or more non-RF measurements.
Clause 97. The non-transitory computer-readable storage medium of any of clauses 93-95, wherein the object feature report comprises a common set of features reported for different non-RF sensors used to generate the one or more non-RF measurements.
Clause 98. The non-transitory computer-readable storage medium of clause 97, wherein the common set of features for the target object comprises one or more of radar cross section, radar cross section variance, speed, position, trajectory, direction, or a combination thereof.
Clause 99. The non-transitory computer-readable storage medium of any of clauses 93-98, wherein the object feature report further comprises a time stamp associated with the one or more non-RF measurements.
Clause 100. The non-transitory computer-readable storage medium of any of clauses 93-99, wherein the object feature report further comprises an object identity (ID) associated with each feature.
Clause 101. The non-transitory computer-readable storage medium of any of clauses 93-100, wherein the object feature report further comprises an indication of a report period.
Clause 102. The non-transitory computer-readable storage medium of any of clauses 93-101, wherein the program code further comprises instructions to send a request to the network node or receiving a request from the network node to prioritize object features for the target object.
Clause 103. The non-transitory computer-readable storage medium of any of clauses 93-102, wherein object feature reports are received periodically from the network node, determining there is no update to one or more object features that are not received in a report period.
Clause 104. The non-transitory computer-readable storage medium of any of clauses 93-103, wherein the object feature report has a format for object features that is used in a received RF sensing measurement report for the target object.

Therefore, it is intended that claimed subject matter not be limited to the particular examples disclosed, but that such claimed subject matter may also include all aspects falling within the scope of appended claims, and equivalents thereof.

What is claimed is:

1. A method performed by a network node in a wireless network for supporting radio frequency (RF) sensing in the wireless network comprising:
obtaining one or more non-RF measurements associated with a target object of RF sensing;
determining one or more object features associated with the target object based on the one or more non-RF measurements;
generating an object feature report comprising the one or more object features associated with the target object; and
sending the object feature report to a server in the wireless network.

2. The method of claim 1, wherein the one or more non-RF measurements comprises measurements performed by one or more of a camera, ultra-sound sensor, lidar, and barometer.

3. The method of claim 1, further comprising sending a capability message to the server indicating support for object feature reporting.

4. The method of claim 3, further comprising receiving an indication of object features to be included in the object feature report.

5. The method of claim 1, wherein determining the one or more object features comprises determining different object features for each different non-RF sensor used for the one or more non-RF measurements.

6. The method of claim 1, wherein determining the one or more object features comprises determining a common set of object feature for different non-RF technologies used for the one or more non-RF measurements.

7. The method of claim 6, wherein the common set of object feature comprises one or more of radar cross section, radar cross section variance, speed, position, trajectory, direction, or a combination thereof.

8. The method of claim 1, wherein the object feature report further comprises a time stamp associated with the one or more non-RF measurements.

9. The method of claim 1, wherein the object feature report further comprises an object identity (ID) associated with each object feature.

10. The method of claim 1, wherein the object feature report further comprises in indication of a report period.

11. The method of claim 1, further comprising prioritizing the object feature report over another object feature report.

12. The method of claim 11, wherein prioritization of the object feature report is dynamically requested by the server or requested by the network node.

13. The method of claim 1, further comprising:
obtaining a subsequent set of one or more non-RF measurements associated with the target object of RF sensing;
determining a change in one or more object features determined from the subsequent set of the one or more non-RF measurements with respect to the one or more object features in the object feature report is less than a threshold; and
not reporting the one or more object features.

14. The method of claim 1, wherein the object feature report has a format for object features that is used in an RF sensing measurement report for the target object sent to the server.

15. A network node in a wireless network configured for supporting radio frequency (RF) sensing in the wireless network, comprising:
at least one transceiver;
one or more non-RF sensors;
at least one memory; and
at least one processor coupled to the at least one transceiver, the one or more non-RF sensors, and the at least one memory, wherein the at least one processor is configured to cause the network node to:
obtain, from the one or more non-RF sensors, one or more non-RF measurements associated with a target object of RF sensing;
determine one or more object features associated with the target object based on the one or more non-RF measurements;
generate an object feature report comprising the one or more object features associated with the target object; and
send, via the at least one transceiver, the object feature report to a server in the wireless network.

16. The network node of claim 15, wherein the one or more non-RF sensors comprise one or more of a camera, ultra-sound sensor, lidar, and barometer.

17. The network node of claim 15 wherein the at least one processor is further configured to send, via the at least one transceiver, a capability message to the server indicating support for object feature reporting.

18. The network node of claim 17, wherein the at least one processor is further configured to receive, via the at least one transceiver, an indication of object features to be included in the object feature report.

19. The network node of claim 15, wherein the at least one processor is configured to determine the one or more object features by being configured to determine different object features for each different non-RF sensor used for the one or more non-RF measurements.

20. The network node of claim 15, wherein the at least one processor is configured to determine the one or more object features by being configured to a common set of object feature for different non-RF technologies used for the one or more non-RF measurements.

21. The network node of claim 20, wherein the common set of object feature comprises one or more of radar cross section, radar cross section variance, speed, position, trajectory, direction, or a combination thereof.

22. The network node of claim 15, wherein the object feature report further comprises a time stamp associated with the one or more non-RF measurements.

23. The network node of claim 15, wherein the object feature report further comprises an object identity (ID) associated with each object feature.

24. The network node of claim 15, wherein the object feature report further comprises in indication of a report period.

25. The network node of claim 15, wherein the at least one processor is further configured to prioritize the object feature report over another object feature report.

26. The network node of claim 25, wherein prioritization of the object feature report is dynamically requested by the server or requested by the network node.

27. The network node of claim 15, wherein the at least one processor is further configured to:
obtain, from the one or more non-RF sensors, a subsequent set of one or more non-RF measurements associated with the target object of RF sensing;
determine a change in one or more object features determined from the subsequent set of the one or more non-RF measurements with respect to the one or more object features in the object feature report is less than a threshold; and
not report the one or more object features.

28. The network node of claim 15, wherein the object feature report has a format for object features that is used in an RF sensing measurement report for the target object sent to the server.

29. A method performed by a server in a wireless network for supporting radio frequency (RF) sensing in the wireless network comprising:
sending to a network node an indication of object features of a target object of RF sensing to be included in an object feature report; and
receiving the object feature report from the network node comprising one or more object features determined by the network node based on one or more non-RF measurements associated with the target object of RF sensing.

30. The method of claim 29, wherein the one or more non-RF measurements comprises measurements performed by one or more of a camera, ultra-sound sensor, lidar, and barometer.

31. The method of claim 29, further comprising receiving a capability message from the network node indicating support for object feature reporting.

32. The method of claim 29, wherein the object feature report comprises different features for each different non-RF sensor used to generate the one or more non-RF measurements.

33. The method of claim 29, wherein the object feature report comprises a common set of features reported for different non-RF sensors used to generate the one or more non-RF measurements.

34. The method of claim 33, wherein the common set of features for the target object comprises one or more of radar cross section, radar cross section variance, speed, position, trajectory, direction, or a combination thereof.

35. The method of claim 29, wherein the object feature report further comprises a time stamp associated with the one or more non-RF measurements.

36. The method of claim 29, wherein the object feature report further comprises an object identity (ID) associated with each feature.

37. The method of claim 29, wherein the object feature report further comprises an indication of a report period.

38. The method of claim 29, further comprising sending a request to the network node or receiving a request from the network node to prioritize object features for the target object.

39. The method of claim 29, wherein object feature reports are received periodically from the network node, determining there is no update to one or more object features that are not received in a report period.

40. The method of claim 29, wherein the object feature report has a format for object features that is used in a received RF sensing measurement report for the target object.

41. A server in a wireless network configured for supporting radio frequency (RF) sensing in the wireless network comprising:
at least one transceiver;
at least one memory; and
at least one processor coupled to the at least one transceiver, and the at least one memory, wherein the at least one processor is configured to cause the server to:
send, via the at least one transceiver, to a network node an indication of object features of a target object of RF sensing to be included in an object feature report; and
receive, via the at least one transceiver, the object feature report from the network node comprising one or more object features determined by the network node based on one or more non-RF measurements associated with the target object of RF sensing.

42. The server of claim 41, wherein the one or more non-RF measurements comprises measurements performed by one or more of a camera, ultra-sound sensor, lidar, and barometer.

43. The server of claim 41, wherein the at least one processor is further configured to receive, via the at least one transceiver, a capability message from the network node indicating support for object feature reporting.

44. The server of claim 41, wherein the object feature report comprises different features for each different non-RF sensor used to generate the one or more non-RF measurements.

45. The server of claim 41, wherein the object feature report comprises a common set of features reported for different non-RF sensors used to generate the one or more non-RF measurements.

46. The server of claim 45, wherein the common set of features for the target object comprises one or more of radar cross section, radar cross section variance, speed, position, trajectory, direction, or a combination thereof.

47. The server of claim 41, wherein the object feature report further comprises a time stamp associated with the one or more non-RF measurements.

48. The server of claim 41, wherein the object feature report further comprises an object identity (ID) associated with each feature.

49. The server of claim 41, wherein the object feature report further comprises an indication of a report period.

50. The server of claim 41, wherein the at least one processor is further configured to send, via the at least one transceiver, a request to the network node or receiving a request from the network node to prioritize object features for the target object.

51. The server of claim 41, wherein object feature reports are received periodically from the network node, determining there is no update to one or more object features that are not received in a report period.

52. The server of claim 41, wherein the object feature report has a format for object features that is used in a received RF sensing measurement report for the target object.
